(19) United States
(12) Patent Application Publication
(10) Pub. No.: US 2009/0306943 A1
(43) Pub. Date: Dec. 10, 2009

(54) METHODS, SYSTEMS AND COMPUTER PROGRAM PRODUCTS FOR REDUCED ORDER MODEL ADAPTIVE SIMULATION OF COMPLEX SYSTEMS

(75) Inventors: Hany S. Abdel-Khalik, Raleigh, NC (US); Paul J. Turinsky, Raleigh, NC (US)

Correspondence Address: MYERS BIGEL SIBLEY & SAJOVEC, PO BOX 37428, RALEIGH, NC, 27627, US

(73) Assignee: North Carolina State University

(21) Appl. No.: 11/867,975

(22) Filed: Oct. 5, 2007

Related U.S. Application Data
(60) Provisional application No. 60/828,256, filed on Oct. 5, 2006.

(51) Int. Cl. G06G 7/54; G06G 7/48

(52) U.S. Cl. 703/2; 703/6

(57) ABSTRACT

Methods, systems and computer program products for selecting input data, including operational parameters for a nuclear system using a reduced order model of a complex computational model are provided. The complex computational model includes a set of equations that describe the nuclear system. An adjoint model associated with the complex model can be obtained, and output data from the adjoint model can be calculated using a plurality of r random sets of input data to the adjoint model. A degree of correlation of the calculated adjoint output data can be determined. A plurality of k reduced correlation subsets of the plurality of r adjoint output data sets can be downselected based on the degree of correlation, such that k<r. The plurality of k reduced correlation subsets of the adjoint output data can be input as a plurality of input data sets to the complex computational model to provide a plurality of k output data sets. A reduced order model for the complex computational model of the nuclear system can be determined based on the plurality of k input and output data sets of the complex computational model. Input and/or output data, including operational parameters for the nuclear system, can be selected using the reduced order model.

### RELATED APPLICATIONS

This application claims priority U.S. Provisional Application No. 60/828,256 filed Oct. 5, 2006, the disclosure of which is hereby incorporated by reference in its entirety.

### FIELD OF THE INVENTION

The present invention relates to simulation of complex systems, and more particularly, to simulation of complex nuclear reactor systems.

### BACKGROUND

A wide variety of complex engineering systems are described by very demanding computational models. The mathematical description of such models generally include a set of partial integro-differential equations that form the basis of the computer-based simulators used to predict the behavior of the associated engineering systems. Many times the accuracy of the simulation is determined by the accuracy of the input data, which may be important to complete design, economic and/or safety analyses of the system. Making experimental observations of the system's performance and contrasting these observations with simulator predictions of performance provides a basis for improving the accuracy of the simulation by adjusting the input data. This process is referred to as adaptive simulation. For complex systems that involve a large number of equations, a large number of input data, and/or large number of metrics describing the system's performance, adaptive simulation may not be computationally feasible due to prohibitive computational burdens on computer memory, speed and/or storage requirements.

By way of example, nuclear power plants are required to routinely collect data about the reactor core's behavior as part of normal operations and startup physics test programs conducted after each refueling outage, e.g. every 18 or 24 months. This data heretofore may not have been interpreted in an integrated fashion to modify the input to nuclear core simulators (codes) to improve prediction accuracy. Core simulators are utilized in designing reload cores so that they meet safety, engineering performance and economic objectives and constraints. Core simulators are also used online to interpret core instrumentation readings, relating them to safety and engineering limits, and to predict future core performance based upon operator directed actions. Enhancement of core simulator fidelity when used in a design setting can allow reduction of design margins, which can be translated into more economical core designs. Enhancement of the core simulator fidelity when used in an online setting can allow increased operating freedom and/or more precise predictions of core behavior, resulting in increased energy generation via improved load maneuvering capability and/or avoided plant trips. To put things into economic perspective, one day of lost energy generation from a large nuclear power plant may translate into increased fuel cycle cost of $150,000 to $500,000 depending upon replacement power fuel source. A 1% savings in fuel cycle costs due to a more aggressive core design made possible by decreased design margins can translate to $400,000 per year.

### SUMMARY OF EMBODIMENTS OF THE INVENTION

According to embodiments of the present invention, methods, systems and/or computer program products for selecting input data, including operational parameters for a nuclear system using a reduced order model of a complex computational model are provided. The complex computational model includes a set of equations that describe the nuclear system. An adjoint model associated with the complex computational model can be obtained, and output data from the adjoint model can be calculated using a plurality of r random sets of input data to the adjoint model. A degree of correlation of the calculated adjoint output data can be determined. A plurality of k reduced correlation subsets of the plurality of r adjoint output data sets can be downselected based on the degree of correlation, such that k<r. The plurality of k reduced correlation subsets of the adjoint output data can be input as a plurality of input data sets to the complex computational model to provide a plurality of k output data sets. A reduced order model for the complex computational model of the nuclear system can be determined based on the plurality of k input and output data sets of the complex computational model. Input and/or output data, including operational parameters for the nuclear system, can be selected using the reduced order model.

According to further embodiments of the present invention, methods and computer program products are provided for selecting input data, including operational parameters for a complex system using a reduced order model of a complex computational model. The complex computational model includes a set of equations that describe the complex system. An adjoint model associated with the complex model can be obtained, and output data from the adjoint model can be calculated using a plurality of r random sets of input data to the adjoint model. A degree of correlation of the calculated adjoint output data can be determined. A plurality of k reduced correlation subsets of the plurality of r adjoint output data sets can be downselected based on the degree of correlation, such that k<r. The plurality of k reduced correlation subsets of the adjoint output data can be input as a plurality of input data sets to the complex computational model to provide a plurality of k output data sets. A reduced order model for the complex computational model of the complex system can be determined based on the plurality of k input and output data sets of the complex computational model. Input and/or output data, including operational parameters for the complex system, can be selected using the reduced order model.

### BRIEF DESCRIPTION OF THE DRAWINGS

FIGS. 1 and 2 are flow charts illustrating operations according to embodiments of the present invention.

FIG. 3 is a schematic diagram illustrating systems, methods and computer program products according to embodiments of the present invention.

FIG. 4 is a graph of the standard deviation in k_{eff} as a function of burnup in a boiling water reactor (BWR) core simulation according to embodiments of the present invention.

FIG. 5 is a graph of the standard deviations in relative nodal power as a function of axial position at the beginning of a cycle, middle of a cycle, and end of a cycle in a BWR core simulation according to embodiments of the present invention.

FIG. 6 is a graph of k_{eff} differences before and after adaption using two covariance libraries in a BWR core simulation according to embodiments of the present invention.

FIG. 7 is a graph of the nodal power RMS errors as a function of burnup in a BWR core simulation according to embodiments of the present invention.

FIG. 8 is a graph of the posterior standard deviation in k_{eff} in a BWR core simulation according to embodiments of the present invention.

FIG. 9 is a graph of the posterior relative nodal power standard deviations in a BWR core simulation according to embodiments of the present invention.

FIG. 10 is a graph of the nodal power errors as a function of burnup in a BWR core simulation according to embodiments of the present invention.

### DETAILED DESCRIPTION OF EMBODIMENTS OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. As used herein, the term “and/or” includes any and all combinations of one or more of the associated listed items.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium, could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. However, software embodiments of the present invention do not depend on implementation with a particular programming language. It will be further appreciated that the functionality of any or all of the program modules may also be implemented using discrete hardware components, one or more application specific integrated circuits (ASICs), or a programmed digital signal processor or microcontroller.

The present invention is described below with reference to block diagram and flowchart illustrations of methods, apparatus (systems) and computer program products according to embodiments of the invention. It will be understood that each block of the block diagrams and/or flowchart illustrations, and combinations of blocks, can be implemented by computer program instructions and/or hardware operations. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

According to some embodiments of the present invention, methods, systems and computer program products are provided that can model a physical system (nuclear, mechanical, biological, social, etc.) by obtaining input data about the physical system, obtaining a complex set of equations that model the system, reducing the set of equations as described herein, and applying the input data to the reduced set of equations to model the physical system. Experimental observations and/or desired observables may be repeatedly compared with simulated results, to adapt the input data to the complex set of equations that model the system. The adaption includes using the reduced set of equations, also referred to as a reduced order model.

In particular, complex systems are often modeled via representation by a large set of complex equations which form the basis of computer based simulators for these complex systems. Large amounts of input data are generally required to utilize such simulators. If the number of equations can be significantly reduced, then adaptive simulation may become more feasible.

Some embodiments of the invention can provide a mathematical basis and associated computer operations, e.g., for accomplishing adaptive simulation of complex systems.

Although embodiments according to the current invention are discussed herein with respect to nuclear power systems, a wide variety of complex systems may be described by demanding computational models, and reduced order models according to embodiments of the current invention can be used to reduce the computational demands of such calculations. Embodiments according to the present invention include methods and computer program products for modeling complex systems, including adaptive simulation of complex systems, and have wide applicability to a range of complex systems, including physical, biological, and social systems, e.g., including, e.g., social networks modeling systems, meteorological modeling systems, weather modeling systems, climate modeling systems, satellite data assimilation systems for numerical weather forecast, sea surface temperature modeling systems, ocean research modeling systems, environmental systems, geophysical systems, earth atmosphere modeling systems, earthquake modeling systems, ecological systems, modeling systems that model interactions between physical and biological systems, medical imaging systems, machine-learning systems, information retrieval systems, and/or data mining systems. Embodiments of the invention provide can be used for data mining of existing experimental observation data associated with complex systems to improve the fidelity of complex system modeling, thereby reducing the uncertainty in predictions of the system's attributes.

The computational feasibility can be achieved by constructing a reduced order model for the complex computational model describing the complex system of interest. Model reduction techniques have been used extensively in many engineering and scientific disciplines: they provide low dimensional approximations to the complex computational models, and may require much less computer resources in terms of memory, speed, and/or storage, to manipulate. In addition to adaptive simulation, reduced order models are also used for a variety of scientific and research-oriented applications, e.g. sensitivity analysis to determine the rate of changes of system's performance metrics with respect to input data changes, uncertainty analysis to quantify uncertainties in system's performance metrics due to input data uncertainties, etc.

According to embodiments of the current invention, methods and computer program products can be used to select operational parameters for a complex system, e.g., a nuclear system, using a reduced order model of a complex model. The complex model includes a set of equations that describe the complex system. A corresponding adjoint model associated with the complex model can be obtained. As described herein, the adjoint model and the complex set of equation comprising the complex model can be used to derive a reduced order model for the complex model.

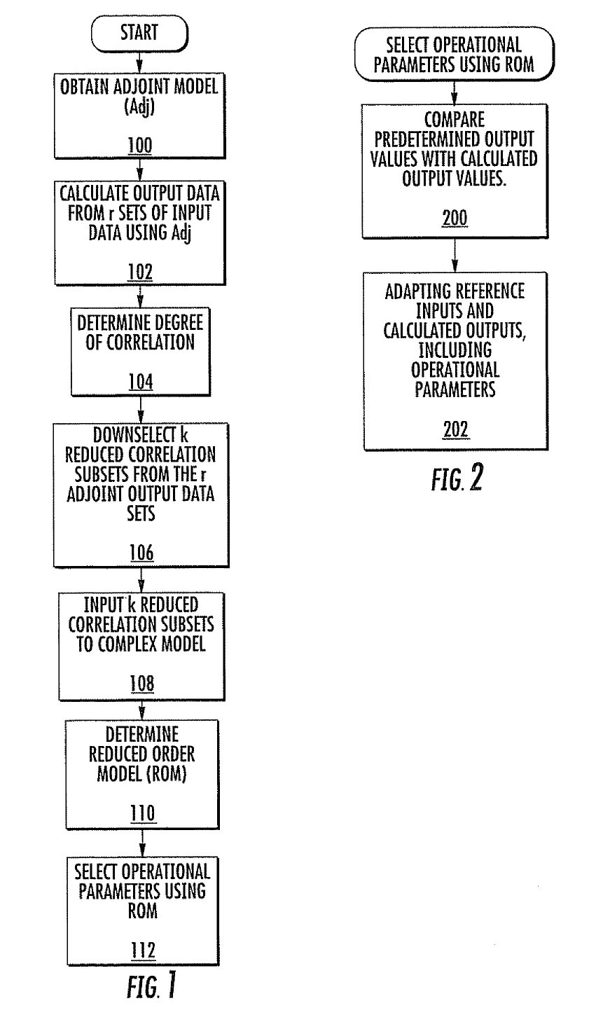

As illustrated in FIG. 1, an adjoint model for the complex model is obtained (Block 100), and output data from the adjoint model is calculated using a plurality (r) of random sets of input data to the adjoint model (Adj) (Block 102). A degree of correlation of the calculated adjoint output data is determined (Block 104), and a plurality of (k) reduced correlation subsets are downselected from the plurality of (r) adjoint output data sets based on the degree of correlation (Block 106). The plurality of (k) reduced correlation subsets of the adjoint output data are input as a plurality of input data sets to the complex computational model to provide a plurality of output data sets (Block 108). A reduced order model for the complex computational model of the nuclear system can be determined based on the plurality of (k) input and output data sets of the complex computational model (Block 110). Input and/or output data, including operational parameters, can be selected for the system using the reduced order model (Block 112).

For example, the operational parameters can include nuclear data, coefficients associated with empirical correlations embedded in the complex set of equations, power output for a nuclear reactor system, physical constants such as equations of state, thermal conductivity, viscosity, coefficients of expansion, stress strain relationships; correlation coefficients, e.g. critical heat flux, form and friction losses, bypass flow correlation; boundary and initial conditions, e.g. power level, pressure, flow rate, fuel exposure, and isotopic composition.

Accordingly, an adjoint model corresponding to a complex computational model can be used to determine a reduced order model for the complex system. An adjoint model, designated Θ^{adj}, is a model including a plurality of equations having a range numerically perpendicular to a null space of the corresponding complex computational model, designated Θ, such that R(Θ^{adj})⊥N(Θ), where two vectors that belong to the subspaces R(Θ^{adj}) and N(Θ) are numerically perpendicular if the dot product of the two vectors is less than a predetermined numerical error tolerance limit.

As shown in FIG. 1, determining the degree of correlation (Block 104) can include determining a numerical rank k of a matrix of the adjoint output data Y^{adj} based on a predetermined numerical error tolerance limit. The matrix Y^{adj} is defined by: Y^{adj}=[\vec{y}₁^{adj} \vec{y}₂^{adj} . . . \vec{y}ᵣ^{adj}], and \vec{y}ᵢ^{adj}=Θ^{adj}(\vec{x}ᵢ^{adj}) is an i^{th} adjoint output data set associated with an i^{th} adjoint input data set, and i runs from 1 to r. The numerical rank k of the matrix of adjoint output data sets may be calculated using a matrix revealing decomposition (e.g., Singular Value Decomposition (SVD)) such that Y^{adj}=U^{adj}S^{adj}V^{adjT}, wherein both U^{adj} and V^{adj} have k columns to downselect the k reduced correlation subsets from the r adjoint output data sets (Block 106).

At Block 108, the k reduced correlation subsets can be input to the complex model to provide k subsets of output data from the complex model. The reduced correlation input data and output data sets can be described by two matrices X^{RO}=[\vec{x}₁^{RO} \vec{x}₂^{RO} . . . \vec{x}ₖ^{RO}], and Y^{RO}=[\vec{y}₁^{RO} \vec{y}₂^{RO} . . . \vec{y}ₖ^{RO}], respectively. The matrix X^{RO} may be calculated, optionally using the SVD decomposition method, e.g., as: X^{RO}=U^{adj}U^{adjT}Y^{adj}.

The reduced order model, denoted Θ_{RO}, can be determined at (Block 110) such that: Y^{RO}=Θ_{RO}X^{RO}.

Various techniques for selecting input data, including operational parameters using the reduced order model in Block 112 can be used, including adaptive simulation and mathematical optimization.

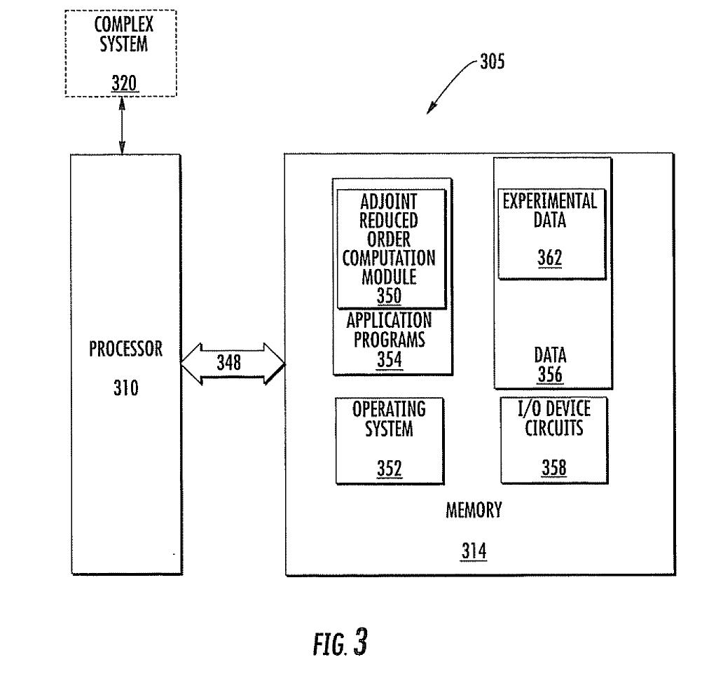

For example, as illustrated in FIG. 2, adaptive simulation can be performed using the reduced order model by comparing predetermined output values with output values calculated by the complex computational model based on reference inputs (Block 200). The reference inputs and calculated outputs can be adapted to increase agreement between the predetermined output values and the calculated output values using the reduced order model, and input and/or output values can be selected, including operational parameters for a system, based on the adapted inputs and outputs (Block 202). The predetermined output values can include experimental values or design targeted output values. For example, the input values for a system, including operational parameters for the system, can be selected based on desired or design targeted output values. As another example, the predetermined output values can be experimentally determined.

FIG. 3 is a block diagram of exemplary embodiments of data processing systems that include an adjoint reduced order computation module 350 and a complex system 320 in accordance with embodiments of the present invention.

The processor 310 communicates with the memory 314 via an address/data bus 348. The processor 310 can be any commercially available or custom enterprise, application, personal, pervasive and/or processor. The memory 314 is representative of the overall hierarchy of memory devices containing the software and data used to implement the functionality of the data processing system 305. The memory 314 can include, but is not limited to, the following types of devices: cache, ROM, PROM, EPROM, EEPROM, flash memory, SRAM, and DRAM.

As shown in FIG. 3, the memory 314 may include several categories of software and data used in the data processing system 305: the operating system 352; the application programs 354; the input/output (I/O) device drivers 358; the adjoint reduced order computation module 350; and the data 356. The adjoint reduced order computational computation module 350 includes computer program code that performs operations according to the current invention, such as described with respect to FIGS. 1 and 2. For example, the complex system 320 can be a nuclear system, such as a nuclear power systems, and associated nuclear fuel cycles used for design, operational and training purposes, and adaptive simulation based on the reduced order computational module 350 can be used to select input data, including operational parameters (e.g., parameters such as neutronic parameters comprising nuclear data; physical parameters comprising equation of state, thermal conductivity, viscosity, coefficient of expansion, stress-strain relationship; correlations parameters comprising critical heat flux, form and friction losses, bypass flow correlation; boundary and initial conditions parameters comprising power level, pressure, flow rate, fuel exposure, isotopic composition) to achieve a desired result, such as increasing the agreement between experimentally determined and computer-calculated core attributes, such as nuclear reactor core power distribution and reactivity). Other examples of nuclear systems include the related supporting experimental programs for nuclear power systems and nuclear fuel cycles, in which one seeks to identify key input data, including operational parameters that contribute the more significantly to the calculated output data, thereby re-directing and optimizing experimental programs.

Although embodiments of the current invention are described herein with respect to nuclear systems, it should be understood that the reduced order computational module 350 can be used to select operating parameters for a variety of complex systems that can be described by a complex computational model, including social systems (e.g. social networks modeling), meteorological models (e.g. weather and climate modeling, and satellite data assimilation for numerical weather forecast, sea surface temperature, and ocean research), environmental systems, geophysical systems (e.g. earth atmosphere, and earthquake modeling), biological systems, ecological systems, and interaction between physical and biological systems), medical imaging, machine learning, information retrieval techniques, and data mining techniques. Embodiments of the current invention may be applied to any suitable complex model and/or field that utilizes the construction of reduced order models, also known as low rank approximations to large-scale matrices in order to perform model adaption.

The data 356 may include experimental data 362 which may be obtained from the complex system 320. The experimental data 362 can be used for adaptive simulation as described herein.

As will be appreciated by those of skill in the art, the operating system 352 may be any operating system suitable for use with a data processing system, such as OS/2, AIX or OS/390 from International Business Machines Corporation, Armonk, N.Y., WindowsCE, WindowsNT, Windows95, Windows98, Windows2000, WindowsXP or Windows XT from Microsoft Corporation, Redmond, Wash., PalmOS from Palm, Inc., MacOS from Apple Computer, UNIX, FreeBSD, or Linux, proprietary operating systems or dedicated operating systems, for example, for embedded data processing systems.

The I/O device drivers 358 typically include software routines accessed through the operating system 352 by the application programs 354 to communicate with devices such as I/O data port(s), data storage 356 and certain memory 314 components and/or the complex system 320. The application programs 354 are illustrative of the programs that implement the various features of the data processing system 305 and preferably include at least one application that supports operations according to embodiments of the present invention. Finally, the data 356 represents the static and dynamic data used by the application programs 354, the operating system 352, the I/O device drivers 358, and other software programs that may reside in the memory 314.

While the present invention is illustrated, for example, with reference to the computation module 350 being an application program in FIG. 3, as will be appreciated by those of skill in the art, other configurations may also be utilized while still benefiting from the teachings of the present invention. For example, the module 350 may also be incorporated into the operating system 352, the I/O device drivers 358 or other such logical division of the data processing system 305. Thus, the present invention should not be construed as limited to the configuration of FIG. 3, which is intended to encompass any configuration capable of carrying out the operations described herein.

The I/O data port can be used to transfer information between the data processing system 305 and the system 320 or another computer system or a network (e.g., the Internet) or to other devices controlled by the processor. These components may be conventional components such as those used in many conventional data processing systems, which may be configured in accordance with the present invention to operate as described herein.

While the present invention is illustrated, for example, with reference to particular divisions of programs, functions and memories, the present invention should not be construed as limited to such logical divisions. Thus, the present invention should not be construed as limited to the configuration of FIG. 3 but is intended to encompass any configuration capable of carrying out the operations described herein.

Embodiments according to the present invention will now be discussed with respect to the following non-limiting exemplary calculations.

### Calculations

Section I presents the mathematical theorems on which finding a reduced order model or a low rank approximation to a matrix operator is based. Section II demonstrates an adaptive simulation experiment employing the reduced order model.

### Section I: Random Theory

The construction of reduced order models, or low rank approximation of matrix operators, is based on three novel mathematical theorems. This section discloses these theorems along with their rigorous mathematical proofs. See H. S. Abdel-Khalik and P. J. Turinsky, “Subspace Methods for Multi-Scale/Multi-Physics Calculations, Part I: Theory” Transactions of American Nuclear Society, Boston, 96, 2007, the disclosure of which is hereby incorporated by reference.

### Theorem I:

Let A∈R^{m×n}* be a pre-defined matrix with rank r, such that r≦n. Let the URV decomposition of A be given by A=URV^{T}, where R is a nonsingular square matrix of rank r and the matrices U and V each have a set of orthonormal columns. Let X∈R^{n×r} be a matrix of randomly generated entries. Then X has a unique decomposition such that:

X=X^{∥}+X^{⊥} (1)

where X^{∥}=VV^{T}X with full column rank r and R(X^{∥})=R(V); R(.) denotes the range of a matrix operator. *In this context, A represents a complex set of equations that describe a complex system

### Theorem II:

Given A, X, and U as defined above, the matrix Y∈R^{m×r} defined by Y=AX* has full column rank r and R(Y)=R(U). *In this context, X describes a plurality of input data sets to the complex set of equations, and Y describes an associated plurality of output data sets.

### Theorem III:

Given A, X, and V as defined above, and Z∈R^{k×r} a random matrix, and an arbitrary matrix B∈R^{k×n}* such that R(B^{T})=R(A^{T}). The matrix W∈R^{n×r} defined by W=B^{T}Z* has full column rank r and R(W)=R(V). * In this context, B^{T} represents an adjoint model associated with complex set of equations that describe the complex system.

A hypothesis and a set of following lemmas are introduced to construct rigorous proofs to these theorems.

### Hypothesis:

Let x be a pre-defined scalar, it is hypothesized that the probability of generating x on the next run of a pseudo-random number generator is zero. In this context, it is assumed that the pseudo-random numbers generated are real, i.e. with infinite precision, and are selected from a uniform probability distribution. However, calculations described herein can be calculated using computers, which are finite memory machines and hence cannot store real numbers with infinite precision. With finite precision arithmetic, the probability of generating a pre-defined number x will be non-zero depending on the machine accuracy. This effect can be ignored and assumed to be very small and hence negligible.

### Lemma 1:

Let \vec{y} be a pre-defined vector of dimension n such that ∥\vec{y}∥≠0 and let \vec{x} be a randomly generated vector of the same dimension, then the following strict inequality holds:

0<|\vec{x}^{T}\vec{y}|<∥\vec{x}∥∥\vec{y}∥ (2)

### Proof:

According to Cauchy-Schwarz, for any two vectors \vec{x} and \vec{y}, where ∥x∥, ∥y∥≠0, the following inequality holds:

0≦|\vec{x}^{T}\vec{y}|≦∥\vec{x}∥∥\vec{y}∥

Notice that the strict inequality is the only difference between this equation and the assertion in Eq (2). This lemma is proved by contradiction. First, assume that |\vec{x}^{T}\vec{y}|=≠0−\vec{x} and \vec{y} are orthogonal—then the following relationship holds:

$${\sum }_{j = 1}^{n} {x}_{j} {y}_{j} = 0 \qquad ( 3 )$$

From that, the n^{th} component of \vec{x} must satisfy:

$${x}_{n} = - \frac{1}{{y}_{n}} {\sum }_{j = 1}^{n - 1} {x}_{j} {y}_{j} \qquad ( 4 )$$

where |yₙ|0. If however |yₙ|=0, re-order the components of the vector \vec{y} such that the last one is not zero; this is possible since ∥\vec{y}∥≠0. Given that xₙ is a randomly generated number, its probability of satisfying Eq (4) above is zero, hence |\vec{x}^{T}\vec{y}|≠0. Second, assume that |\vec{x}^{T}\vec{y}|=∥\vec{x}∥∥\vec{y}∥−\vec{x} and \vec{y} are parallel—then the following relationship holds:

xⱼ=ayⱼ (5)

where |a|≠0. Eq (5) above implies that all of the randomly generated components of the vector \vec{x} must be equal to some pre-defined values. According to the hypothesis, the probability of generating a pre-defined number is zero, hence |\vec{x}^{T}\vec{y}|≠∥\vec{x}∥∥\vec{y}∥. The lemma is then proved.

In more qualitative terms, this lemma implies that any randomly generated vector can be decomposed into two non-zero components: one along any pre-defined direction in the space and the other orthogonal to that pre-defined direction.

### Lemma 2:

Let Y be a pre-defined subspace with dimension s, and let Y=span{\vec{y}₁, \vec{y}₂, . . . , \vec{y}ₛ}. Then, if \vec{x} is randomly generated, the following is true:

0<|\vec{y}ⱼ^{T}\vec{x}|<∥\vec{y}ⱼ∥∥\vec{x}∥ (j=1, . . . , s) (6)

### Proof:

This lemma follows directly from the previous one. In more qualitative terms, it implies that for any randomly generated vector, it will always have non-zero components along each vector in any set of vectors spanning a certain subspace.

### Lemma 3:

Let Y∈Rⁿ be a pre-defined subspace as in lemma 2 and \vec{x} a randomly generated vector. Then, the following relationship holds:

G\vec{x}≠0 (7)

G\vec{x}≠\vec{x} (8)

where G is the orthogonal projector onto the subspace Y.

### Proof:

First, assume G\vec{x}=\vec{0}−\vec{x} is perpendicular to the subspace Y, i.e. \vec{x}^{T}\vec{y}=0 for every \vec{y}∈Y−\vec{x} is perpendicular to any pre-defined vector in the subspace Y. This contradicts with lemma 2, hence the first assumption is wrong. Therefore G\vec{x}≠\vec{0}.

Second, assume that G\vec{x}=\vec{x}−\vec{x} belongs to the subspace Y. Consider Z the complementary orthogonal subspace to Y, such that: Z⊕Y=Rⁿ and Z⊥Y. Note that the subspace Z is unique once Y is defined. Now, since \vec{x}∈Y then \vec{x}⊥Z. According to the first part of this lemma, if Z is a pre-defined subspace, then \vec{x} cannot be perpendicular to Z. Accordingly, the assumption that G\vec{x}=\vec{x} cannot be valid. Therefore, G\vec{x}≠\vec{x}. This completes the proof of this lemma. Note that x−G\vec{x} is the component of \vec{x} orthogonal to the subspace Y.

### Lemma 4:

Let Y be a pre-defined subspace as in lemma 2. For a randomly generated vector \vec{x}, the following is true:

\vec{x}=λ₁\vec{y}₁+λ₂\vec{y}₂+ . . . +λₛ\vec{y}ₛ+\vec{y}^{⊥} (9)

where \vec{y}^{⊥}⊥Y.

### Proof:

The coefficients {λⱼ} are the components of x along the vectors {\vec{y}ⱼ} and are given by:

\vec{λ}=(Y^{T}Y)⁻¹Y^{T}\vec{x} (10)

where Y=[\vec{y}₁ \vec{y}₂ . . . \vec{y}ₛ]. Let (Y^{T}Y)⁻¹Y^{T}=B=[\vec{b}₁ \vec{b}₂ . . . \vec{b}ₛ], then λⱼ=\vec{b}ⱼ^{T}\vec{x}.

According to lemma 1, \vec{b}ⱼ is a pre-defined vector, and \vec{x} is randomly generated, hence |\vec{b}ⱼ^{T}\vec{x}|≠0 [symbol] |λⱼ|≠0.

The orthogonal projection of \vec{x} onto the subspace Y may then be given by:

G\vec{x}=λ₁\vec{y}₁+λ₂\vec{y}₂+ . . . +λₛ\vec{y}ₛ

Now, by definition, the vector \vec{y}^{⊥}=\vec{x}−G\vec{x} is the component of \vec{x} orthogonal to the subspace Y. According to lemma 3, G\vec{x}≠\vec{x}, then ∥\vec{x}−G\vec{x}∥≠0 [symbol] ∥\vec{y}^{⊥}≠0.

### Lemma 5:

Let Y be a pre-defined subspace with dimension s≧2, and let \vec{x}₁ and \vec{x}₂ be two randomly generated vectors. Then, G\vec{x}₁ and G\vec{x}₂ are independent, where G is the orthogonal projector onto the subspace Y.

### Proof:

Generate the first random vector \vec{x}₁ and consider its projection onto the subspace Y given by G\vec{x}₁. Let Y=span{G\vec{x}₁, \vec{y}₂, . . . , \vec{y}ₛ}, and Ŷ=span{\vec{y}₂, . . . , \vec{y}ₛ} is a subspace whose basis vectors are arbitrarily selected after the random vector \vec{x}₁ is generated such that: span{G\vec{x}₁}⊥Ŷ. Let G_{y} be the orthogonal projector onto the subspace Ŷ. Now, generate the second random vector; according to lemma 4, the following is true:

\vec{x}₂=λ₁G\vec{x}₁+λ₂\vec{y}₂+ . . . +λₛ\vec{y}ₛ+\vec{y}^{⊥}, |λⱼ|≠0 (j=1, . . . , s) and ∥\vec{y}^{⊥}∥≠0

where \vec{y}^{⊥}⊥Y and the projection of \vec{x}₂ onto the subspace Y is given by:

G\vec{x}₂=λ₁G\vec{x}₁+λ₂\vec{y}₂+ . . . +λₛ\vec{y}ₛ (11)

Further, the projection of x₂ onto the subspace Y is given by:

(G_{y}\vec{x}₂=λ₂\vec{y}₂+ . . . +λₛ\vec{y}ₛ)⊥G\vec{x}₁ (12)

where according to lemma 2:

G_{y}\vec{x}₂≠0 [symbol] λ₂\vec{y}₂+ . . . +λₛ\vec{y}ₛ≠\vec{0} (13)

From Eq (12), G\vec{x}₁ and λ₂\vec{y}₂+ . . . +λₛ\vec{y}ₛ are orthogonal, and from Eq (13), λ₂\vec{y}₂+ . . . +λₛ\vec{y}ₛ≠\vec{0}. Since |λ₁|≠0, it is clear the that G\vec{x}₁ and G\vec{x}₂ are independent as implied from Eq (11).

### Lemma 6:

Let Y be a pre-defined subspace with dimension s, and let \vec{x}₁, \vec{x}₂, . . . , \vec{x}ᵣ be r randomly generated vectors, where r≦s. Then, G\vec{x}₁, G\vec{x}₂, . . . , G\vec{x}ᵣ are independent, where G is the orthogonal projector onto the subspace Y.

### Proof:

Assume that this lemma is valid till k such that k<r, i.e. G\vec{x}₁, G\vec{x}₂, . . . , G\vec{x}ₖ are independent. Let Y=span{G\vec{x}₁, G\vec{x}₂, . . . , G\vec{x}ₖ, \vec{y}ₖ₊₁, \vec{y}ₖ₊₂, . . . , \vec{y}ₛ}.

Like before, let the subspace Ŷ be given by:

\hat{Y}=span{\vec{y}ₖ₊₁, \vec{y}ₖ₊₂, . . . , \vec{y}ₛ}⊥span{G\vec{x}₁, G\vec{x}₂, . . . , G\vec{x}ₖ}

and let G_{y} be the orthogonal projector onto the subspace Ŷ. Now, consider generating the next random vector \vec{x}ₖ₊₁, which according to lemma 4 may be written as:

\vec{x}ₖ₊₁=λ₁G\vec{x}₁+λ₂G\vec{x}₂+ . . . +λₖG\vec{x}ₖ+λₖ₊₁\vec{y}ₖ₊₁+ . . . +λₛ\vec{y}ₛ+\vec{y}^{⊥}

The projection of \vec{x}ₖ₊₁ onto the subspace Y is given by:

G\vec{x}ₖ₊₁=λ₁G\vec{x}₁+λ₂G\vec{x}₂+ . . . +λₖG\vec{x}ₖ+λₖ₊₁\vec{y}ₖ₊₁+ . . . +λₛ\vec{y}ₛ

whereas the projection of \vec{x}ₖ₊₁ onto the subspace Ŷ is given by:

(G_{y}\vec{x}ₖ₊₁=λₖ₊₁\vec{y}ₖ₊₁+ . . . +λₛ\vec{y}ₛ)⊥span{G\vec{x}₁, G\vec{x}₂, . . . , G\vec{X}ₖ}

Therefore, as before G\vec{x}ₖ₊₁ is linearly independent from the set of vectors G\vec{x}₁, G\vec{x}₂, . . . , G\vec{x}ₖ. Clearly, when r=s, the vectors G\vec{x}₁, G\vec{x}₂, . . . , G\vec{x}ᵣ span the entire subspace Y; therefore, the projection of any other randomly generated vector will be a linear combination of the latter basis vectors, and hence will not be linearly independent any more.

### Proof of Theorem I:

Let Y be a subspace such that Y=span{\vec{v}₁, \vec{v}₂, . . . , \vec{v}ᵣ}=R(V), where {\vec{v}ⱼ} form an orthonormal set of vectors. Since the columns of V form an orthonormal basis for the subspace Y, the orthogonal projector onto the subspace Y can simply be written as:

G=VV^{T}

Now, let the columns of the matrix X be given by: X=[\vec{x}₁ \vec{x}₂ . . . \vec{x}ᵣ], where each column represents a randomly generated vector. According to lemma 6, the vectors G\vec{x}₁, G\vec{x}₂, . . . , G\vec{x}ᵣ form a linearly independent set. Then, the matrix [G\vec{x}₁ G\vec{x}₂ . . . G\vec{x}ᵣ] has rank r. This matrix may be re-written as:

[G\vec{x}₁ G\vec{x}₂ . . . G\vec{x}ᵣ]=GX=VV_{T}X=X^{∥}

Therefore, the matrix X^{∥} has full column rank r. Note that both X^{∥}=VV^{T}X=VV^{T}X^{∥} and V have full column rank, therefore the square matrices V^{T}X=V^{T}X^{∥}∈R^{r×r} are nonsingular, i.e. of rank r

### Proof of Theorem II:

Now consider the matrix Y∈R^{m×r} such that Y=AX. Introducing the URV decomposition of A, one obtains:

Y=AX=URV^{T}(X^{∥}+X^{⊥})=URV^{T}X^{∥}

Here, the three matrices V^{T}X^{∥}, R, and U have full column rank. Therefore, the resulting product Y has full column rank as well. Note that each column of the matrix Y belongs to R(U), since Y is full rank, i.e. consists of r independent columns. Further, dim(R(U))=r, then R(Y)=R(U)

### Proof of Theorem III:

Let the URV decomposition of B be given by:

B=U_{B}R_{B}V_{B}^{T} (14)

Now, since R(B^{T})⊥N(A), and by definition: R(A^{T})⊥N(A) and R(A^{T})⊕N(A)=Rⁿ; then R(B^{T})=R(A^{T}) [symbol] R(V_{B})=R(V), one can re-write Eq (14) as follows:

B=U_{B}R_{B}^{ROT}V^{T}

where R_{B}^{ROT}=R_{B}D, and D is an orthonormal matrix, i.e. D^{T}D=DD^{T}=I, that rotates the columns of V_{B} to align with the columns of V, i.e. V_{B}D=V. To prove R(W)=R(V), follow the same analysis in theorem I proof but now replace A by B^{T}, and X by Z.

In a qualitative sense, the results of these theorems are: for a matrix A with rank r, and a set of r randomly generated vectors, only r matrix-vector products are required to produce bases that span the unique subspaces of the matrix A (recall A represents the complex set of equations describing the complex system); these subspaces are the range of the matrix A, R(A) spanned by the columns of the matrix U, and the range of the matrix B^{T}, R(B^{T}) (recall matrix B^{T} represents the adjoint model of the complex set of equations) spanned by the columns of the matrix V. Finding these subspaces can be used to efficiently find a low rank approximation to a matrix, i.e., a reduced order model for a complex matrix.

### Section II: Reduced Order Model-Based Adaptive Simulation

This section describes how the reduced order model is utilized to perform adaptive simulation for a complex computational model, e.g., a model involving millions of input data and output data.

In this context, adaptive simulation is a mathematical technique that a) compares predetermined, e.g. experimentally-evaluated, with computer-calculated output data based on a prior (i.e. reference) set of input data to the computational model describing the engineering system of interest, and b) inverts the reduced order model approximating the action of the computational model, c) to modify the a prior input data in order to enhance the agreement between the predetermined and computer-calculated output data; such that d) the input data are modified in a manner that ensures that they are statistically consistent with their a prior values.

Adaptive simulation involves three general steps:
Step 1: construct a reduced order model of the form:

Y^{RO}=Θ_{RO}X^{RO}

Step 2: select the size of input data adjustments that minimizes the quadratic function (See A. N. Tikhonov, “Regularization of incorrectly posed problems,” Soviet Mathematics Doklady, 4, 1624 (1963)):

$${min}_{\overline{a}} {‖ {\vec{y}}^{m} - {\vec{y}}_{0} - {Y}^{RO} \vec{a} ‖}_{{C}_{{y}^{m}}^{- 1}} + {λ}^{2} {‖ {X}^{RO} \vec{a} ‖}_{{C}_{x}^{- 1}}$$

where \vec{y}^{m} are the predetermined output data, e.g. experimental observations, \vec{y}₀ the reference computer-calculated output data, C_{y}_{^{m}} and Cₓ are the predetermined output data, and input data covariance matrices, respectively; and λ² is a regularization parameter selected by means of the L-curve. See H. W. Engl and W. Grever, “Using the L-Curve for determining optimal regularization parameters”, Numerische Mathematik, 69, 25 (1994).
Step 3: calculate the posteriori input data (post adaption) \vec{x}ₚₒₛₜ as:

\vec{x}ₚₒₛₜ=\vec{x}₀+X^{RO}\vec{a}

where \vec{x}₀ are the reference input data, including operational parameters (i.e. prior to adaption)

### EXAMPLE 1

### Evaluation of Boiling Water Reactor (BWR) Core Attributes Uncertainties due to Multi-Group Cross-Group Cross-Section Uncertainties

### 1. Introduction

Understanding uncertainties in key reactor core attributes associated with BWR core simulation is important in regard to introducing appropriate design margins, and deciding where additional efforts should be undertaken to reduce uncertainties. Uncertainties in core simulation predictions occur due to input data uncertainties, modeling errors, and numerical approximations. Input data to a typical core simulator primarily include the lattice-averaged few-group cross-sections, and the various coefficients that appear in many of the empirical correlations used in reactor calculations, e.g. heat transfer coefficients, void-quality correlations parameters, etc. Previous work by Abdel-Khalik and Turinsky has shown that cross-sections uncertainties play a significant role in the core attributes uncertainties for a BWR core loaded with LEU fuel [1].

This example continues investigation into cross-section uncertainty propagation using Efficient Subspace Method (ESM).

ESM is used to perform sensitivity and uncertainty analysis for applications with large input/output (I/O) streams while minimizing the number of required model modifications and evaluations [2]. ESM is based on matrix-revealing decompositions, e.g. singular value decomposition (SVD), which identifies the effective number of degrees of freedom (DOFs), i.e. informational content, of the I/O streams—that is the number of independent pieces of information of potential importance that are transferred through the computational models. In previous work, ESM has shown that the sensitivity matrix of a typical BWR core simulator has a very small effective rank, i.e. small number of potentially important DOFs, compared to the matrix dimensions, a sensitivity matrix which relates changes in calculated responses to changes in input data; it has m×n entries, where m is the number of calculated responses and n number of input data. This implies significant contraction of the information carried by the input data and high degree of induced correlations among the calculated responses. ESM takes advantage of this situation by limiting the sensitivity and uncertainty analyses to the potentially important independent information that is transferred through the computational model. In this approach, accurate low-rank approximations of the sensitivity and uncertainty matrices can be created directly without ever forming the full matrices, thus reducing the computational and storage burdens. For this work, the SVD of the multi-group covariance library is shown to favorably limit the required number of lattice physics calculations and core simulations needed for both uncertainty propagation and adaptive simulation.

Section 2 describes how ESM is used for uncertainty propagation, adaptive simulation, and posterior uncertainty estimation by SVD. The multi-group cross-section covariance matrix is propagated through the lattice physics calculations to calculate the lattice-averaged few-group cross-section covariance matrix. This covariance matrix is propagated through the core simulator to determine uncertainty in BWR core attributes. The covariance matrices and model sensitivities are then used to improve agreement between two different core simulator models with one simulator assumed to represent real plant data and the other an existing design basis core simulator. The adapted simulator is used to update the cross-sections and core attributes covariance matrices, often referred to as posteriori covariance matrices. Section 3 provides results and analysis of these calculations followed by conclusions in Section 4.

### 2. Methods

The following notation will be used throughout the example: C̅ denotes a matrix, with [ C̅]ᵢⱼ being the i-th row and j-th column entry; and [ C̅]_{i*} the i-th row, and [ C̅]_{*j} the j-th column. x̅ denotes a vector with the k-th entry, { x̅}ₖ. Finally, Θ(•) represents a nonlinear operator.

In order to propagate first and second order moments of input data uncertainties through a computational model to the calculated model responses, one can use: a) the covariance matrix of the input data, and b) the sensitivity matrix characterizing the change in calculated responses with respect to the change in input data [3]. The computational model is represented by the lattice physics and the core simulation calculations. Let Θ denote the computational model, such that:

y̅=Θ( x̅) (1)

where x̅ is an n-th dimensional column vector of input parameters, y̅ is an m-th dimensional column vector of output responses, and the sensitivity (or Jacobian) matrix Θ̅ of the computational model can be defined as:

$${[ {Θ}^{\overline{\_}} ]}_{ij} = \frac{\partial {\{ \overline{y} \}}_{i}}{\partial {\{ \overline{x} \}}_{j}} {\vert}_{{\overline{x}}_{0}} \qquad ( 2 )$$

for i=1, . . . , m, and j=1, . . . , n, where all partial derivatives are evaluated at a reference input x̅₀ producing output y̅₀=Θ( x̅₀). Given C̅ₓ the input parameters covariance matrix, the second order moment of output responses' uncertainties may be characterized by:

C̅_{y}= Θ̅ C̅ₓ Θ̅^{T} (3)

where C̅_{y} is the output responses covariance matrix. It is noted that relative sensitivity and relative covariance matrices were used. Absolute sensitivity and covariance matrices are presented to simplify notations.

In conventional uncertainty analysis approaches, C̅_{y} is directly calculated by the triple matrix product in Eq. 3, where Θ̅ is calculated using forward or adjoint methods. The forward method requires n+1 forward calculations where [ Θ̅]_{*j} is:

$${[ {Θ}^{\overline{\_}} ]}_{* j} = \frac{Θ ( {\overline{x}}_{0} + ɛ {\overline{e}}_{j} ) - {\overline{y}}_{0}}{ɛ} \qquad ( 4 )$$

and ∈ is a scaling factor chosen to produce a linear response for Θ near x̅₀. Likewise, adjoint methods require m+1 adjoint calculations to calculate Θ̅.

### 2.1. Uncertainty Propagation

The effective rank of the input parameters covariance matrix C̅ₓ is found to be very small compared to the total number of input parameters. This implies that only a small subset of input data has independent uncertainty information. The selected DOFs were based on the SVD of C̅ₓ and used to calculate C̅_{y} in the following equivalent formulation using only r+1 forward model evaluations. Note that r is selected by ordering the singular values from high to low, and then selecting r such that the r+1 singular value is several orders of magnitude smaller than the 1^{st} singular value. In what follows, it will be assumed usage of the effective rank introduces error that can be ignored, so effective rank and rank can be considered equivalent. Note that the sensitivity matrix of the computational model, also found to be of low rank, is expected to decrease the number of DOFs propagated through the lattice physics even further, however with very low r, the required number of forward model evaluations is computationally feasible.

Now, express the compact SVD of C̅ₓ as:

C̅ₓ= U̅ₓ Σ̅ₓ U̅ₓ^{T} (5)

where U̅ₓ∈R^{n×r} with r orthogonal columns that span the range of C̅ₓ, and Σ̅ₓ∈R^{r×r} is a diagonal matrix of singular values. Substituting for C̅ₓ in Eq. 3, C̅_{y} reduces to:

C̅_{y}= R̅_{y} Σ̅ₓ R̅_{y}^{T} (6)

where R̅_{y}= Θ̅ U̅ₓ∈R^{m×r} is defined as the response matrix whose j-th column represents the action of the sensitivity matrix along the j-th column of U̅ₓ, i.e. the directional derivative along the j-th column of U̅ₓ, whose matrix-free [4] forward difference approximation is:

$${[ {{R}^{\overline{\_}}}_{y} ]}_{* j} = {{Θ}^{\overline{\_}} [ {{U}^{\overline{\_}}}_{x} ]}_{* j} = \frac{Θ ( {\overline{x}}_{0} + {ɛ [ {{U}^{\overline{\_}}}_{x} ]}_{* j} ) - {\overline{y}}_{0}}{ɛ} \qquad ( 7 )$$

where ∈ is again a scaling factor chosen to produce a linear response for Θ near x̅⁰. The columns of U̅ₓ are referred to as the principal directions of C̅ₓ.
Eq. 6 is used to determine the lattice-averaged few-group cross-section covariance matrix C̅_{FG} from the multi-group covariance matrix C̅_{MG}:

C̅_{FG}= R̅ₗ Σ̅_{MG} R̅ₗ^{T} (8)

where R̅ₗ= Θ̅ₗ U̅_{FG} is the lattice physics response matrix with sensitivity matrix Θ̅ₗ. The multi-group covariance matrix is constructed using the multi-group covariance libraries (44GROUPV5COV and 44GROUPANLCOV) provided in the SCALE 5.0 package [5]. These libraries were generated by the multi-group preparation code PUFF-III [6], which processes the ENDF/V point-wise covariance data. Likewise, the core attributes covariance matrix C̅_{CA} can be calculated as:

C̅_{CA}= Θ̅_{c} R̅ₗ Σ̅_{MG} R̅ₗ^{T} Θ̅_{c}^{T} (9)

where Θ̅_{c} is the core simulator sensitivity matrix. The response matrix representation is formed by the SVD of R̅ₗ Σ̅_{MG}^{1/2}= U̅_{FG} Σ̅_{FG}^{1/2} Ψ̅^{T}. Eq. 9 becomes:

$$\begin{matrix}{{C}^{\overline{\_}}}_{CA} = {{Θ}^{\overline{\_}}}_{c} {{U}^{\overline{\_}}}_{FG} {{Σ}^{\overline{\_}}}_{FG}^{1 / 2} {{Ψ}^{\overline{\_}}}^{T} {Ψ}^{\overline{\_}} {{Σ}^{\overline{\_}}}_{FG}^{1 / 2} {{U}^{\overline{\_}}}_{FG}^{T} {{Θ}^{\overline{\_}}}_{c}^{T} \\ = {{Θ}^{\overline{\_}}}_{c} {{U}^{\overline{\_}}}_{FG} {{Σ}^{\overline{\_}}}_{FG} {{U}^{\overline{\_}}}_{FG}^{T} {{Θ}^{\overline{\_}}}_{c}^{T} \\ = {{R}^{\overline{\_}}}_{c} {{Σ}^{\overline{\_}}}_{FG} {{R}^{\overline{\_}}}_{c}^{T}\end{matrix} \qquad ( 10 )$$

with R̅_{c}= Θ̅_{c} U̅_{FG} is the core simulator response matrix.

For this problem, the I/O streams are very large: a) ˜10³ multi-group cross-sections input to the lattice physics code, b) ˜10⁶ lattice-averaged few-group cross-sections generated by ˜10² runs of the lattice physics code to functionalize cross-sections in terms of various historical and instantaneous core conditions, e.g. exposure, void, fuel and moderator temperature changes, and control rod insertion, etc., and c) ˜10⁵ core attributes (k_{eff}'s, nodal powers, thermal margins calculated at various points during depletion). Using standard sensitivity analyses would require too many code runs to render a practical approach to uncertainty evaluation. For example, the forward approach would require ˜10⁵ and 10⁶ lattice physics and core simulator runs, respectively, in order to evaluate the full lattice physics' and core simulator's sensitivity matrices, i.e. Θ̅ₗ and Θ̅_{c}. An adjoint sensitivity analysis would require ˜10⁶ and 10⁵ lattice physics and simulators runs, respectively, where the codes have to be run in an adjoint mode which often requires extensive coding effort to implement. In this work, an ESM-based sensitivity analysis is used. This approach evaluates the sensitivity information associated with the effective DOFs only, i.e. the information that is transferred through the lattice physics and core simulators codes. It is noted that the effective DOFs will vary depending on the application. For example, in an uncertainty analysis, one is only interested in propagating uncertainty information for input data that have relatively high-to-moderate uncertainties and high-to-moderate sensitivities. All DOF with zero uncertainties are discarded from the analysis even if they have strong sensitivities since they do not contribute to the propagated uncertainties. To identify the effective DOFs for an uncertainty analysis application, it is recognized that the rank of C̅_{MG} is only 10² due to the high degree of correlation amongst the multi-group cross-sections. This implies that the effective number of DOFs characterizing the few-group cross-sections uncertainties cannot exceed 10². Once identified, one needs to run the core simulator ˜10² times only in order to propagate uncertainties to core attributes. Since the forward calculations are being relied on, one, in general, would need to run the lattice physics code ˜10²×10² times to identify the ˜10² effective DOFs. For this work, the lattice physics response matrix was generated for one representative lattice/void configuration and these results were then fully correlated to all lattice/void configurations, reducing the number of lattice physics computations to 10². Previous work suggests that different lattice/void configurations have different correlations and that in general all lattice/void configurations should be modeled explicitly [2]. A current research area includes developing a fast, accurate low-order lattice physics model that calculates these correlations along with using ESM to determine an accurate low-rank approximation to Θ̅ₗ. The singular value decomposition of C̅_{FG} revealed a decrease in the effective number of DOFs through the lattice physics model; as expected only ˜10² core simulation runs were required to calculate C̅_{CA}.

### 2.2. Adaptive Simulation

Adaptive simulation is an inverse problem that minimizes the residual between a set of measurements and model predictions by adjusting model input data [2]. For BWR simulation, adjusting n=10⁶ lattice-averaged few-group cross-sections to reduce or minimize the discrepancies between m=10⁵ measured and predicted core attributes can be accomplished. It should be understood that the measurements may be based on real plant data; however in this example a virtual approach has been adopted, where one core simulator's predictions are assumed to represent real plant data while another simulator is taken to represent an existing design basis core simulator. With the large size of input and output data of a typical core simulator, it is apparent that a prohibitive number of forward and/or adjoint simulator runs will be required to explicitly calculate Θ̅_{c}. This is necessary for any Gradient-based nonlinear least-squares solver, e.g. Newton or quasi-Newton-type methods [4]. As presented, the adaption problem is undetermined since the number of equations m is less than the number of unknowns n. Mathematically, this problem is referred to as being ill-posed [7], where one cannot obtain a unique solution. In addition, it has been demonstrated that any noise inherent in the measurements can lead to an unreliable adaption. To re-cast an ill-posed problem into a well-posed one, a regularization approach is often used and, specifically, Tikhonov Regularization has been adopted [8]. In addition, the few-group cross-sections adjustments have also been constrained to a subspace spanned by the singular vectors of the covariance matrix C̅_{FG}. This is done to ensure statistical consistency of the adjusted cross-section. As pointed out earlier, the rank of C̅_{FG} is only of the order of 10², implying that only 10² core simulator runs are required to create the core simulator response matrix R̅_{c}.

In this example, the Tikhonov-regularized objective function is defined as:

$$\begin{matrix}Obj ( \overline{z} ) = {‖ {\overline{y}}_{CA ( m )} - {Θ}_{c} ( {\overline{x}}_{FG} ) ‖}_{{{C}^{\overline{\_}}}_{CA ( m )}^{- 1}}^{2} + {α}^{2} {‖ {\overline{x}}_{FG} - {\overline{x}}_{FGo} ‖}_{{{C}^{\overline{\_}}}_{FG}^{+}}^{2} & ( 11 ) \\ subject to {\overline{x}}_{FG} - {\overline{x}}_{FGo} = {{U}^{\overline{\_}}}_{FG} \overline{z} & ( 12 )\end{matrix}$$

where the first term, known as the misfit term, is the distance between a measured y̅_{CA(m)}∈R^{m} and a predicted y̅_{CA}=Θ_{c}( x̅_{FG}) set of core attributes for some set of lattice-averaged few-group cross-sections x̅_{FG}∈Rⁿ. The misfit norm is weighted by the inverse of the measured core attributes covariance matrix C̅_{CA(m)}. The second term, known as the regularization term, is the distance between x̅_{FG} and the priori values x̅_{FGo} where the norm is weighted by the Moore-Penrose pseudo inverse for C̅_{FG}( C̅_{FG}⁺= U̅_{FG} Σ̅_{FG}⁻¹ U̅_{FG}^{T}). Note that C̅_{FG} is singular. The constraint defined by Eq. 12 ensures that the few-group cross-section adjustments will belong to the subspace spanned by the columns of the matrix U̅_{FG}, where z̅ ∈R^{r} represents the component, e.g. expansion coefficients, of the cross-sections adjustment vector x̅_{FG}− x̅_{FGo} along the columns of the matrix U̅_{FG}. The regularization parameter α is used to control the magnitude of the cross-section adjustments, and is experimentally determined by “trial and error” based on the characteristic ‘L-curve’ [9]. Eq. 11 and Eq. 12 can be reduced to the following linear least squares minimization problem:

Obj( z̅)=∥ b̅− A̅ z̅∥₂² (13)

where A̅∈R^{m+r×r} is of full column rank such that Eq. 13 can be solved by orthogonal decomposition or direct solution to the normal equation, i.e. {tilde over ( z̅=( A̅^{T} A̅)⁻¹ A̅^{T} b̅. To show that, starting with the SVD of C̅_{CA(m)}, one can re-write Eq. 11 using the following 2-norm expression:

$$\begin{matrix}Obj ( \overline{z} ) = {‖ {{Σ}^{\overline{\_}}}_{CA ( m )}^{- 1 / 2} {{U}^{\overline{\_}}}_{CA ( m )}^{T} ( {\overline{y}}_{CA ( m )} - {Θ}_{c} ( {\overline{x}}_{FG} ) ) ‖}_{2}^{2} + \\ {α}^{2} {‖ {{Σ}^{\overline{\_}}}_{FG}^{- 1 / 2} {{U}^{\overline{\_}}}_{FG}^{T} ( {\overline{x}}_{FG} - {\overline{x}}_{Go} ) ‖}_{2}^{2} \\ = {‖ {{Σ}^{\overline{\_}}}_{CA ( m )}^{- 1 / 2} {{U}^{\overline{\_}}}_{CA ( m )}^{T} ( {\overline{y}}_{CA ( m )} - {Θ}_{c} ( {\overline{x}}_{FG} ) ) ‖}_{2}^{2} + {α}^{2} {‖ {{Σ}^{\overline{\_}}}_{FG}^{- 1 / 2} \overline{z} ‖}_{2}^{2}\end{matrix} \qquad ( 14 )$$

where z̅= U̅_{FG}^{T}( x̅_{FG}− x̅_{FGo}) is substituted into the regularization term from Eq. 12. The core simulator model can be linearized about x̅_{FGo} such that:

y̅_{CA}=Θ_{c}( x̅_{FG})≈ y̅_{CAo}+ Θ̅_{c}( x̅_{FG}− x̅_{FGo})= y̅_{CAo}+ Θ̅_{c} U̅_{FG} z̅= y̅_{CAo}+ R̅_{c}\vec{z} (15)

where y̅_{CAo}≡Θ_{c}( x̅_{FGo}) and R̅_{c} is the core simulator response matrix. Substituting Eq. 15 into Eq. 14 yields:

$$\begin{matrix}{‖ {{Σ}^{\overline{\_}}}_{CA ( m )}^{- 1 / 2} {{U}^{\overline{\_}}}_{CA ( m )}^{T} ( {\overline{y}}_{CA ( m )} - {\overline{y}}_{CAo} - {{R}^{\overline{\_}}}_{c} \overline{z} ) ‖}_{2}^{2} + {α}^{2} {‖ {{Σ}^{\overline{\_}}}_{FG}^{- 1 / 2} \overline{z} ‖}_{2}^{2} = {‖ \overline{b} - {A}^{\overline{\_}} \overline{z} ‖}_{2}^{2} \\ where & ( 16 ) \\ {A}^{\overline{\_}} ∈ {R}^{m + r \times r} = [ \begin{matrix}{{Σ}^{\overline{\_}}}_{CA ( m )}^{- 1 / 2} {{U}^{\overline{\_}}}_{CA ( m )}^{T} {{R}^{\overline{\_}}}_{c} \\ α {{Σ}^{\overline{\_}}}_{FG}^{- 1 / 2}\end{matrix} ] , \\ and \overline{b} ∈ {R}^{m + r} = [ \begin{matrix}{{Σ}^{\overline{\_}}}_{CA ( m )}^{- 1 / 2} {{U}^{\overline{\_}}}_{CA ( m )}^{T} ( {\overline{y}}_{CA ( m )} - {\overline{y}}_{CAo} ) \\ \overline{0}\end{matrix} ] & ( 17 )\end{matrix}$$

The minimizer of Eq. 16, denoted as

$${z}^{\overline{\sim}} ,$$

is the least-squares solution to the following equation:

$${A}^{\overline{\_}} {z}^{\overline{\sim}} = \overline{b} \qquad ( 18 )$$

Instead of using the normal equations to calculate

$${z}^{\overline{\sim}} , i . e . {z}^{\overline{\sim}} = {( {{A}^{\overline{\_}}}^{T} {{A}^{\overline{\_}}}^{T} )}^{- 1} {{A}^{\overline{\_}}}^{T} \overline{b} ,$$

an SVD-based approach is used to avoid squaring the condition number of the matrix A̅. Calculating the SVD of the top block of A̅ such as:

$${A}^{\overline{\_}} = [ \begin{matrix}{{Σ}^{\overline{\_}}}_{CA ( m )}^{- 1 / 2} {{U}^{\overline{\_}}}_{CA ( m )}^{T} {{R}^{\overline{\_}}}_{c} \\ α {{Σ}^{\overline{\_}}}_{FG}^{- 1 / 2}\end{matrix} ] = [ \begin{matrix}{{U}^{\overline{\_}}}_{A} {{Σ}^{\overline{\_}}}_{A} {{V}^{\overline{\_}}}_{A}^{T} \\ α {{Σ}^{\overline{\_}}}_{FG}^{- 1 / 2}\end{matrix} ] \qquad ( 19 )$$

The minimizer

$${z}^{\overline{\sim}}$$

can then be given by:

$${z}^{\overline{\sim}} = {( {{V}^{\overline{\_}}}_{A}^{T} {{Σ}^{\overline{\_}}}_{A}^{2} {{V}^{\overline{\_}}}^{T} + {α}^{2} {{Σ}^{\overline{\_}}}_{FG}^{- 1} )}^{- 1} {{V}^{\overline{\_}}}_{A} {{Σ}^{\overline{\_}}}_{A} {{U}^{\overline{\_}}}_{A}^{T} \overline{b} \qquad ( 20 )$$

The adaptive simulations may be outlined as follows:

Given: U̅_{FG}, Σ̅_{FG} from the SVD of the few-group covariance matrix, y̅_{CA(m)} the measured core attributes, and C̅_{CA(m)} the covariance matrix of measured core attributes—often a diagonal matrix.

1. Calculate y̅_{CAo}=Θ_{c}( x̅_{FGo})

2. Run the core simulator r times in a forward manner to calculate R̅_{c} (Eq. 7).

3. Calculate the SVD of C̅_{CA(m)} if unknown.

4. Construct A̅ and b̅ from Eq. 17.

5. Solve for

$${z}^{\overline{\sim}}$$

from Eq. 20.

6. Calculate the adapted few-group cross-sections

$${{x}^{\overline{\sim}}}_{FG} = {\overline{x}}_{FG 0} + {{U}^{\overline{\_}}}_{FG} {z}^{\overline{\sim}} .$$

7. Calculate the adapted core attributes

$${{y}^{\overline{\sim}}}_{CA} = {Θ}_{c} ( {{x}^{\overline{\sim}}}_{F} ) .$$

In this implementation, it is assumed that the uncertainties for both the input data (i.e. few-group cross-sections) and measured output data (i.e. core attributes) follow Gaussian probability distributions. This is likely an acceptable assumption for the input data-only the first and second moments (i.e. means and variances) of the cross-sections are available in the evaluated nuclear data files. For the measured core attributes, it is assumed that the measured signals have been corrected for calibration errors prior to being incorporated into the adaption. With these assumptions, one can show the measured core attributes and the posteriori (adjusted) cross-sections will indeed follow Gaussian distributions if the lattice physics and core simulator codes are behaving linearly within the range of the cross-section adjustments [10]. Numerical experiments have revealed that the change in few-group cross-sections is directly proportional to the change in multi-group cross-sections up to perturbations of ˜1-4 standard deviations. This assures that any adjusted data within the tails of the prior distributions will still produce a linear response. The following condition is utilized to assess the linearity of the lattice physics and the core simulator model:

$$Θ ( {\overline{x}}_{0} + {X}^{\overline{\_}} \overline{β} ) - Θ ( {\overline{x}}_{0} ) \approx {\sum }_{i = 1}^{k} [ Θ ( {\overline{x}}_{0} + {{\{ \overline{β} \}}_{i} [ {X}^{\overline{\_}} ]}_{* i} ) - Θ ( {\overline{x}}_{0} ) ] \qquad ( 21 )$$

where β̅∈R^{k} is a vector of perturbation weights, k is the number of perturbations, and the columns of X̅∈R^{n×k} represent random directions along which the input data are perturbed. Eq. 18 was tested for various choices of k, β̅, and X̅ such that the magnitudes of the perturbed cross-sections vary from 0 to 4 standard deviations.

### 2.3 Posterior Covariance Matrices

The posterior uncertainties associated with the solution to an inverse problem can have a significance similar to the posterior solution (i.e. adapted solution). Posterior uncertainty analysis updates the input data uncertainties, i.e. the confidence in their reported values, based on the measured core attributes. Essentially, adaptive simulation utilizes data from additional experiments to increase the confidence about the reported input data. Where now the experiments are a) more complex, i.e. represented by entire sequence of reactor core calculations, and b) indirect, i.e. measured core attributes are utilized to infer information about input data. For BWR simulation, the uncertainty in lattice-averaged few-group cross-sections can be reduced and core attributes uncertainties can be predicted. The posterior probability distributions for the few-group cross-sections and core attributes follow Gaussian distributions since the core simulator behaves linearity over the range of the prior few-group cross-section uncertainties, and thus can be fully described by posterior covariance matrices.

In the following, the uncertainty propagation equation, i.e. C̅_{y}= Θ̅ C̅ₓ Θ̅^{T}, for the linear relationship y̅= Θ̅ x̅ is used to develop expressions for posterior covariance matrices

$${\tilde{C}}_{z} , {\tilde{C}}_{FG} , and {\tilde{C}}_{CA} .$$

One can show that the few-group cross-section covariance matrix

$${\tilde{C}}_{FG}$$

is given by:

$${\tilde{C}}_{FG} = {{U}^{\overline{\_}}}_{FG} {\tilde{C}}_{z} {{U}^{\overline{\_}}}_{FG}^{T} \qquad ( 22 )$$

and the posterior covariance matrix

$${\tilde{C}}_{z}$$

is given by:

$${\tilde{C}}_{z} = {{V}^{\overline{\_}}}_{A} {{B}^{\overline{\_}} ( {α}^{2} )}^{- 1} {B}^{\overline{\_}} ( {α}^{4} ) {{B}^{\overline{\_}} ( {α}^{2} )}^{- 1} {{V}^{\overline{\_}}}_{A}^{T} \qquad ( 23 )$$

where B̅(η) is a matrix operator:

B̅(η)≡( Σ̅_{A}²+η V̅_{A}^{T} Σ̅_{FG}⁻¹ V̅_{A}) (24)

Finally, the posterior core attributes covariance matrix

$${\tilde{C}}_{CA}$$

can be written as:

$${\tilde{C}}_{CA} = {{R}^{\overline{\_}}}_{c} {\tilde{C}}_{z} {{R}^{\overline{\_}}}_{c}^{T} \qquad ( 25 )$$

Note that the rank of the above covariance matrices does not exceeds ˜10²—the effective rank of the multi-group covariance matrix. Therefore one never constructs the full covariance matrices as implied by the above equations; only their SVDs are computed and stored.

### 3. Results

The methods described above were used to quantify core attributes' uncertainties for a BWR/3 reload core design with 540 fuel assembles and a cycle burnup of 16 GWD/MTU. The TRITON [11] lattice physics code developed at ORNL was used to calculate few-group cross-sections. The FORMOSA-B [12] core simulator, developed at North Carolina State University, was used as a core simulator to calculate core attributes of interest. Uncertainties in k_{eff} and nodal power were calculated for the 44GROUPANLCOV multi-group covariance library and the 44GROUPV5COV multi-group covariance library provided in the ORNL SCALE package. The 44GROUPV5COV library contained 600 different covariance matrices for 29 different isotopes. Key uncertainty contributors from this library include plutonium cross-sections and other minor actinide cross-sections for high burnup. The 44GROUPANLCOV library contains an additional 100 different covariance matrices for an additional 30 isotopes such as gadolinium, zirconium, and samarium cross-sections. The uncertainty was assumed to be zero for any cross-section not included in the libraries.

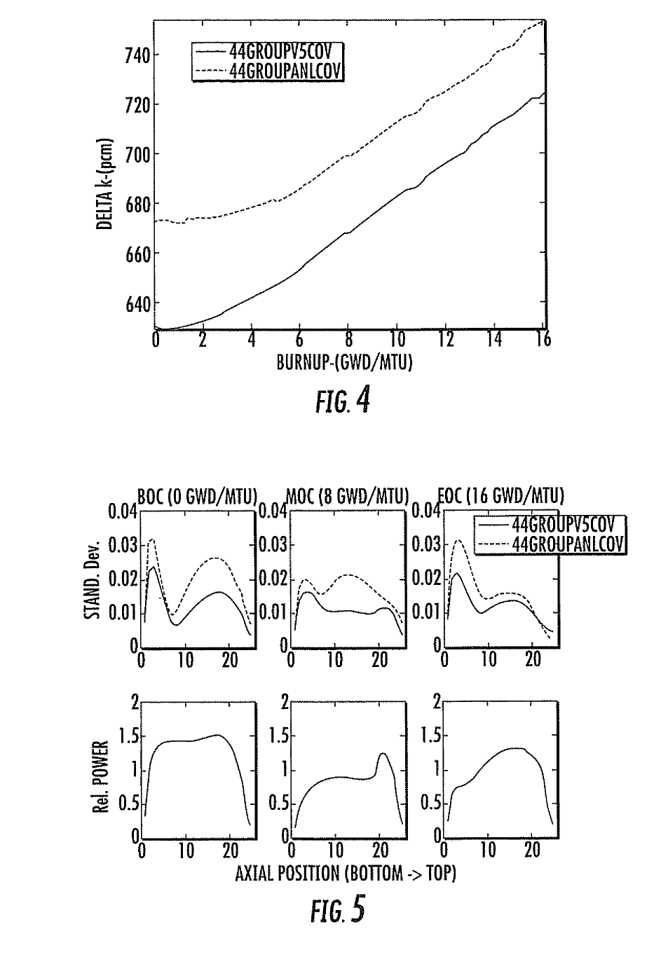

The k_{eff} standard deviation as a function of burnup is shown in FIG. 4 using both covariance libraries. The standard deviation increases with burnup due to plutonium buildup as the core depletes. The k_{eff} standard deviation for the 44GROUPANLCOV library is ˜40 pcm greater than that of the 44GROUPV5COV library which is to be expected since more sources of uncertainties in the multi-group cross-sections are now considered, i.e. the gadolinium cross-sections. As gadolinium depletes, the 44GROUPANLCOV standard deviation increases almost identically to the 44GROUPV5COV standard deviation due to plutonium buildup.

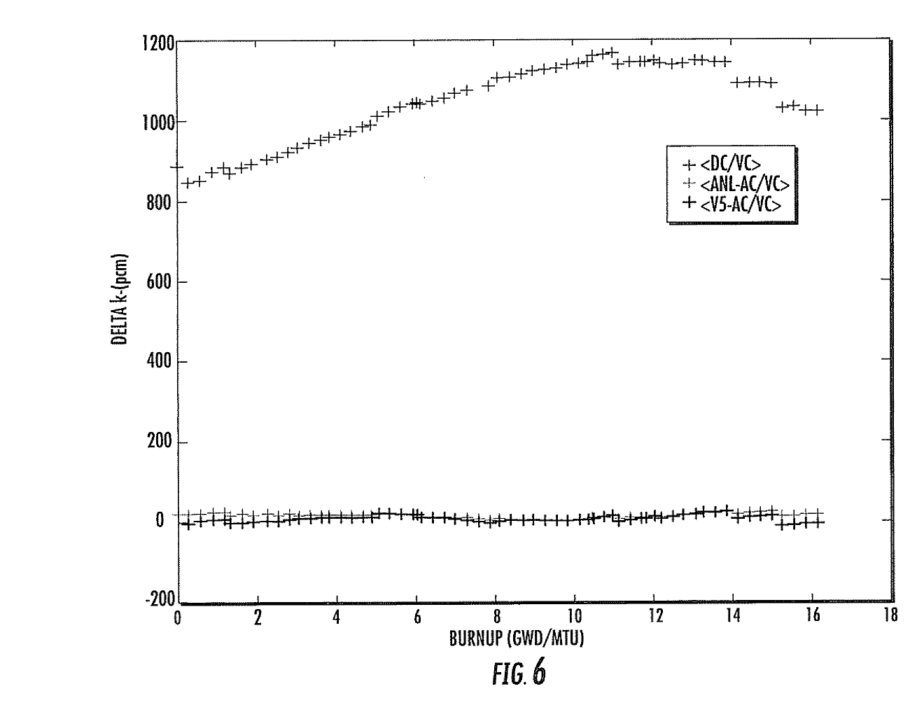

Standard deviations in relative nodal power are shown as a function of axial position at beginning of a cycle (BOC), middle of a cycle (MOC), and end of a cycle (EOS) in FIG. 5. The top three graphs show the standard deviation and the bottom three show the relative power profile for a fresh fuel assembly near the center of the core. The shape of the standard deviation is complicated due to lattice type and history effects such as void, control rod, and burnup. The library difference is the largest at BOC where gadolinium is the key contributor to uncertainty.

An adaptive simulation experiment was conducted using the core attributes uncertainties given in FIGS. 4 and 5 to improve the fidelity of core simulator predictions by adjusting few-group cross-sections. The goal is to use ESM based techniques to adapt core simulators to real plant data. For now, a virtual approach is employed where a design basis core simulator, denoted DC, is adapted to a set of virtual core attributes, denoted VC. The virtual core attributes are generated by perturbing the few-group cross-sections in a statistically consistent manner with their prior uncertainties. Specifically, the VC core attributes are calculated according to:

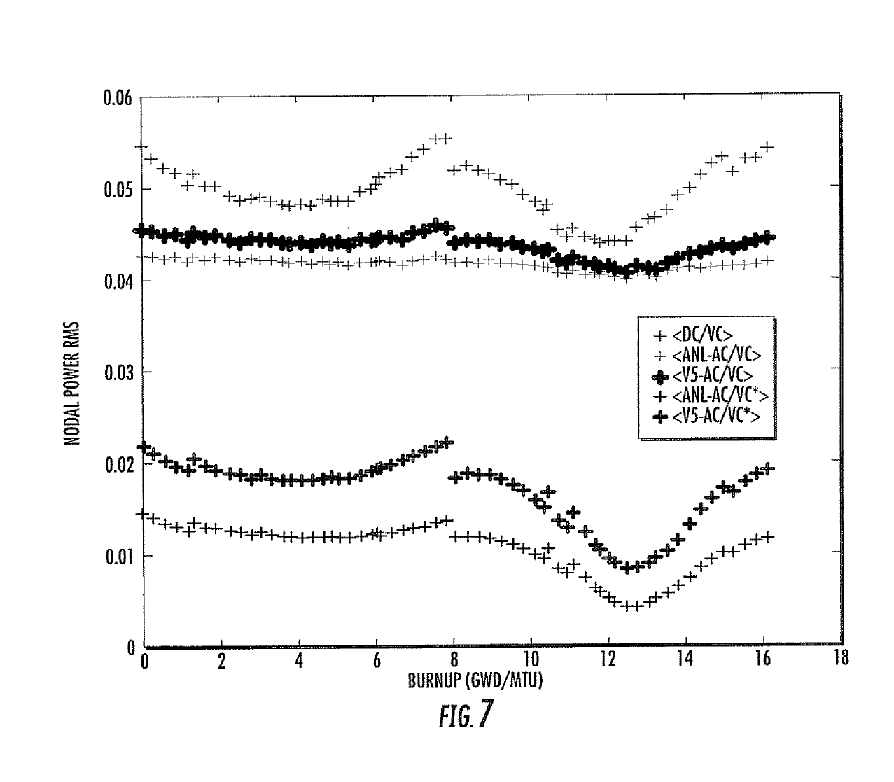

y̅_{CA}(m)^{VC}=Θ( x̅₀+ U̅_{FG} ζ̅) (26)

where the columns of U̅_{FG} are the singular vectors of the prior few-group covariance matrix and ζ̅ denotes the perturbation size. In addition, the nodal powers were perturbed randomly by selecting them from Gaussian distribution with standard deviation of 4% which is representative of the in-core detectors signals' uncertainties. In the graphs that follow, AC denotes the adapted core solution. FIG. 6 shows the k_{eff} differences before and after adaption using both the LANL and ORNL covariance libraries. The original difference <DC/VC> was 800 pcm at BOC and 1000 pcm at EOS. The differences after adaption are denoted <ANL−AC/VC> for the 44GROUPANLCOV library and <V5−AC/VC> for the 44GROUPV5COV library. The error in k_{eff} after adaption is nearly zero. FIG. 7 plots the nodal power RMS errors as a function of burnup. The original nodal power error was 4.5-5.5%. The error decreased to 4.3% for the 44GROUPV5COV library and 4.1% for the 44GROUPANLCOV, consistent with the instrument noise level. Since the noise was simulated in this approach, the RMS errors are recalculated between the AC predictions and VC before the noise is applied, with <ANL−AC/VC*> and <V5−AC/VC*> representing the error in the AC nodal powers and the VC nodal powers before the noise is applied to the virtual core. The reduced RMS errors displayed indicate that the adaption acts as a powerful noise filter. The quality of the LANL-based adaption may be better, which is again expected due to the increased degrees of freedom available for the adaption.

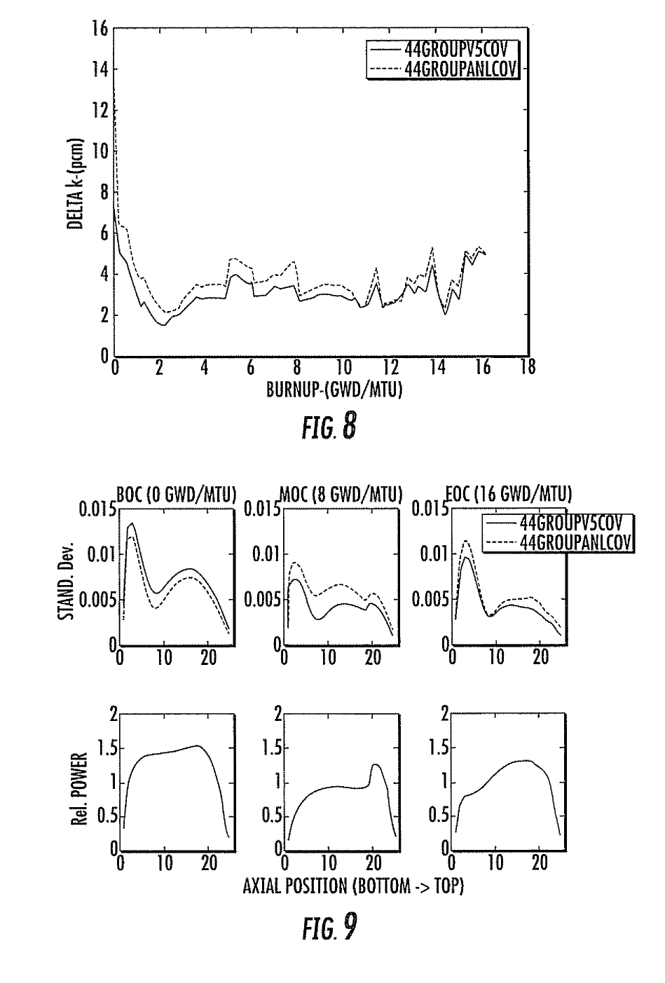

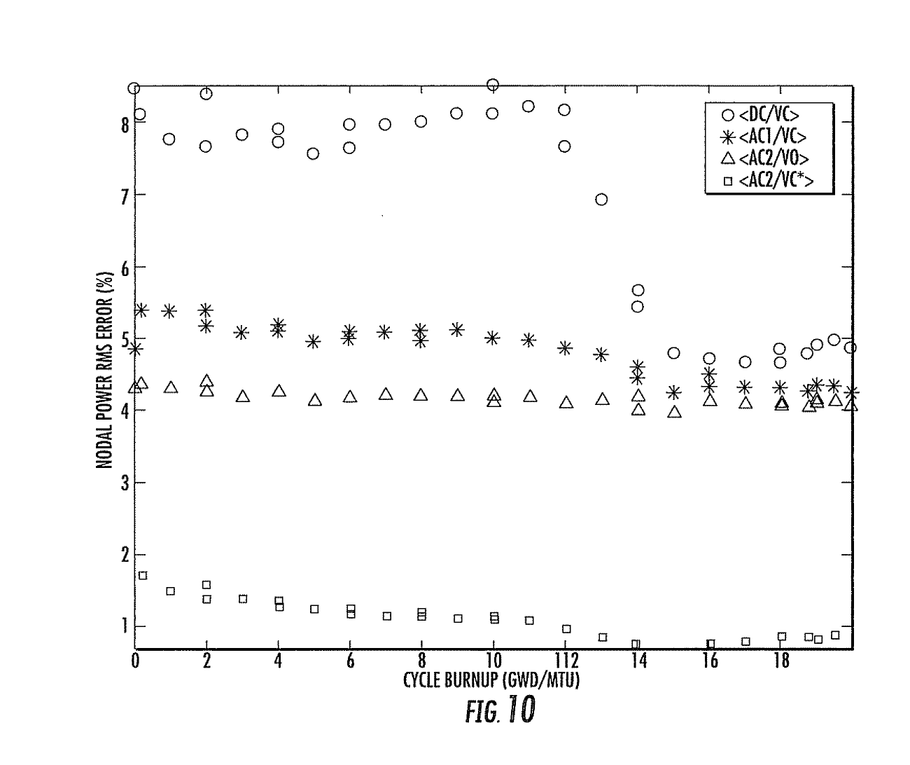

The adapted solution results are used to generate posterior core attributes uncertainties. Posterior k_{eff} standard deviations are reported in FIG. 8 and the posterior relative nodal power standard deviations are in FIG. 9. The posterior uncertainty in k_{eff} for both libraries is of the order of 10 pcm, which is likely less than the uncertainty in k_{eff} due to modeling errors. The posterior uncertainty in nodal powers is less than 2%.

For this numerical experiment, the virtual core is created with the assumption that input data constitute the only source of uncertainties in the calculations. This is achieved by perturbing the reference cross-section along the singular vectors of the few-group prior covariance matrix, see Eq. 26. In reality, other sources of uncertainties are present, such as modeling uncertainties, and numerical errors. In these cases, the fidelity of the AC is expected to be lower since adaption can only correct for input data uncertainties. Previous work has illustrated that when both modeling and input data uncertainties are present, the adaption is shown to adjust a subset of input data outside the range of their prior uncertainties [2]. These data are associated with the models introducing the modeling uncertainties. This helps provide some guidance to modelers on where further modeling development may be required.

### 4. Conclusions

Multi-group cross-section uncertainties have been propagated to uncertainties in core attributes, such as k_{eff} and nodal power, through the lattice physics calculations and core simulations in a computationally efficient manner based on the SVD of the multi-group covariance matrix. Adaptive core simulation has been proposed in which one can adjust for errors in the multitudes of data input to core simulators by utilizing an inverse theory approach that utilizes the discrepancies between measured and predicted core attributes. The key assumptions introduced are a) input data probability distributions can be well represented by normal Gaussian distribution, b) reactor calculations, including lattice physics and core simulations, behave linearly within the range of input data uncertainty, and c) the rank of the associated sensitivity matrices are remarkably low such that few forward calculations are required to evaluate the required matrices for both the uncertainty and the adaptive simulation application. The 44GROUPANLCOV library provided better adaption than the 44GROUPV5COV library due to larger number of degrees of freedom. Current work focuses on the adaption of the multi-group cross-sections rather than few-group cross-sections. This adaption is expected to be more robust since the cross-section adjustments will no longer depend on the specific lattice design and/or even core design; thus eliminating the need to repeat the adaption when a new fuel design is introduced.

### EXAMPLE 2

### Subspace Methods for Multi-Scale/Multi-Physics Calculations Part I

This example discusses Efficient Subspace Methods (ESM) as applied to Multi-Scale/Multi-Physics (MSMP) modeling. Recently, MSMP modeling has proven to be essential to the successful modeling of the full fuel cycle where a wide spectrum of physical processes occur with large variations in time and spatial scales such as neutron physics, heat transfer, partitioning and reprocessing, and waste management, etc. (See Workshop on Simulation and Modeling for Advanced Nuclear Energy Systems, co-sponsored by Office of NE, Office of ACCR, and U.S. DOE, Washington, D.C. Aug. 15-17, 2006 [htt://www-fp.mcs.anl.gov/anes/SMANES/gnep06-final.pdf]). These large variations pose both mathematical and computational challenges due to the complexity of the equations required to describe the coupled physics at the various scales. MSMP use High Resolution (HR) microscopic models to capture the basic physics governing system behavior coupled with Low Resolution (LR) macroscopic models to directly calculate the macroscopic system behavior. In doing so, one must obtain numerical solutions in practical times for the different modeling stages. This is important not only for estimated system behavior predictions at normal conditions, but also for performing other applications essential for system design and optimization, e.g. sensitivity/uncertainty (S/U), and adaptive simulation, which may be more computationally demanding than best-estimate predictions.

The proposed methods will efficiently couple the various modeling stages of a MSMP model in order to reduce the computational times (See Hany Abdel-Khalik, “Adaptive Core Simulation”. Ph.D. Dissertation, North Carolina State University, December 2004)(published after November 2007). This is achieved by extracting minimal information from the microscopic HR models sufficient to accurately predict variations in the macroscopic quantities evaluated by the LR models. Knowledge of the minimal information transferred between the different modeling stages can be used for many applications, e.g. to identify influential parts of the models and/or the input data impacting the calculated macroscopic quantities and to provide insights to areas of models/data which requires further development and/or re-evaluation, etc.

### Efficient Subspace Method

In designing an engineering system, it is important to understand how information, often represented by I/O steams, is passed between the different modeling stages. This follows, since one often introduces design changes on a microscopic level, and is interested in quantifying the impact on the system's macroscopic behavior as measured by a set of constraints to satisfy and objectives to meet. The required design changes can be identified using forward and adjoint sensitivity methods. With complex coupled models, however, this becomes an intractable task, since the model is required to run a number of times equal to the size of the I/O streams. This is because existing approaches assume that each input data carry information that is independent from all other data. In MSMP modeling, this is rarely the case due to the gradual dimensionality reduction throughout the different modeling stages. This creates large degrees of correlations between different data in the I/O streams. One is hence tempted to treat I/O data collectively in search of the independent pieces of information. The term ‘Degree of Freedom’ (DOF) is utilized to denote an independent piece of information in the I/O stream. An active DOF will denote a DOF that is transferred from a higher to a lower resolution model, and an inactive DOF will denote a DOF that is thrown out. The concept of DOF is known; it has been exploited in many other fields, e.g. concept of principal directions in statistics, structure revealing decomposition in linear algebra, etc.

### Case Study

Let π denote the LR model calculating m macroscopic quantities (denoted by vector d̅∈R^{m}), and receiving n input data ( x̅∈Rⁿ) which are the output from the HR model Θ that receives l basic input data (\vec{z}∈R^{l}). This situation is described by:

d̅=\vec{π}( x̅), x̅=\vec{Θ}(\vec{z})

Or to a first order approximation:

\vec{d}−\vec{d}₀=π( x̅− x̅₀), x̅− x̅₀=Θ(\vec{z}−\vec{z}₀)

where both π and Θ are large dense matrix operators (Jacobian). Let the number of DOFs at the LR level be k where k≦1 implying that among the m observables signals, only k are independent with the rest m−k fully correlated. The active DOFs may be represented using matrix revealing decompositions:

d̅− d̅₀=U_{π}R_{π}V_{π}^{T}( x̅− x̅₀), x̅− x̅₀=U_{Θ}R_{Θ}V_{Θ}^{T}(\vec{z}−\vec{z}₀)

where U_{π}∈R_{m×k}^{_{π}}, R_{π}∈R^{k}^{_{π}}^{×k}^{_{π}}, V_{π}∈R^{n×k}^{_{π}}, U_{Σ}∈R^{n×k}^{_{Θ}}, R_{Θ}∈R^{k}^{_{Θ}}^{×k}^{_{Θ}}, V_{Θ}R^{l×k}^{_{Θ}}. The k_{π} and k_{Θ} are the ranks of π and Θ, respectively; R_{π} and R_{Θ} are nonsingular matrices. Both U_{Θ} and V_{Θ} have k_{Θ} columns corresponding to the k_{Θ} active DOFs that are transferred through the HR model to the LR model. The R(V_{Θ}) (Range of the matrix V_{Θ}) and R(U_{Θ}) represent the k_{Θ} active DOFs in the input and output streams of the HR model, respectively (note that any changes along the l−k_{Θ} inactive DOFs cannot induce changes in any of the quantities calculated downstream). When the two models are combined, the total number of DOFs k will satisfy: k≦min(k_{π}, k_{Θ}).

ESM generates the above decompositions directly using computer codes as black boxes without ever evaluating the full dense matrix operators, π and Θ. This is achieved by running the codes first in a forward mode while randomly perturbing all input data to generate the subspaces spanned by the U_{π} and U_{Θ} matrices. This is followed by adjoint runs to find V_{π} and V_{Θ}, where the responses, to which the adjoint solutions are obtained, are restricted to the subspaces R(U_{π}) and R(U_{Θ}). This is based on the following theorem.

Theorem: Let Θ∈R^{m×n} be a pre-defined matrix (representing unknown Jacobian matrix of a computer code) with rank r<n. Let π=URV^{T} be a matrix revealing decomposition as described earlier. Given X∈R^{n×r}, a matrix of randomly generated entries, x has a unique decomposition such that: X=X_{□}+X^{⊥}, where rank(X^{□})=r and R(X^{□})=R(V). Let Y=AX (action of forward model), then rank(Y)=r, and R(Y)=R(U). Further, given Z∈R^{m×r}, a matrix of randomly generated entries, then (w=π*Z)∈R^{n×r} (action of the adjoint model), rank(W)=r, and R(W)=R(V)

### Part II.

Part II demonstrates the use of ESM for enhancing the quality of BWR core calculations which are performed by complex MSMP modeling. BWR core simulation is currently performed by complex Multi-Scale/Multi-Physics (MSMP) computational sequences. The high resolution model involves lattice physics calculations that model 1D neutron transport on the fuel pin level in fine-energy detail to account for resonance and spatial self-shielding, followed by 2D assembly level calculations with less energy detail (20-80 multi-groups). Lattice physics codes generate homogenized few-group cross-sections (2-4 groups) to be used in a low resolution model of a 3D core simulator that couples the neutronic and thermal hydraulic behavior on the core level.

This example presents recent work on the use of Efficient Subspace Methods (ESM), including adaptive simulation using reduced order modeling, to improve the fidelity of BWR modeling predictions. Introduced in Part I of this example, ESM can be used as sensitivity and uncertainty (S/U) analysis tools for MSMP models. This example shows how ESM is used to determine the posterior estimate of few-group cross-sections that minimizes the prediction error of a BWR core simulator.

These calculations will be performed using two different input parameter covariance matrices that characterize the a priori Gaussian probability distribution of the multi-group cross sections. Calculational comparisons using both input covariance matrices are given.

The TRITON lattice physics code (M. D. DEHART, “TRITON: A Two Dimensional Depletion Sequence for Characterization of Spent Nuclear Fuel,” SCALE Code Package: ORNL/TM-2005/39, Version 5, Vol. I (2005).) uses ˜10³ input data representing multi-group cross sections and resonance parameters used to calculate ˜10⁶ output data representing few-group homogenized cross-sections as a function of burnup, fuel color, history effects, and thermal hydraulic conditions for GE14 lattice designs and GE/3 reload core currently studied. The FORMOSA-B core simulator (B. R. MOORE, P. J. TURINSKY and A. A. KARVE, “FORMOSA-B: A Boiling Water Reactor In-core Fuel Management Optimization Package,” Nuclear Technology, 126, 153 (1999)) uses the few-group homogenized cross-sections to predict ˜10⁵ core observables such as reactivity and incore instrument readings.

The large sizes of the I/O streams and long computational run-times make it infeasible to calculate sensitivity (or Jacobian) matrices using forward and adjoint methods. These methods treat each input and output parameters independently in forward and adjoint model approaches, respectively. As shown in Part I, ESM recognizes the correlation of informational content transferred between computational sequences and requires forward (and possibly adjoint) calculations equal to the number of active degrees of freedom (DOF) of informational content in the I/O streams. For BWR simulation, the active DOF is only ˜10².

### Results and Discussion

The covariance matrix of the basic input data to the lattice physics code—infinitely dilute, multi-group cross-sections—can be used to calculate core simulator observables covariance matrix by the following:

C_{d}=SC_{z}S^{T} (1)

where C_{d} is the observables covariance matrix, C_{z} is the multi-group covariance matrix, and s is the combined sensitivity matrix of the lattice-physics and core simulator calculations, i.e. S=πΘ[Following notations of Part I, the high (Θ) and low (π) resolution level models are represented by the lattice physics and core simulation calculations, respectively]. As shown in Part I, ESM uses matrix revealing decompositions of the input covariance matrix and/or the sensitivity matrices of the computational models to minimize the required number of calculations. In this case, the rank of the multi-group covariance matrix was ˜10², so the lattice physics and BWR core simulator were run only ˜10² times with the multi-group cross-sections perturbed along each eigenvector of its covariance matrix (See M. A. JESSEE, H. S. ABDEL-KHALIK, P. J. TURINSKY, “Evaluation of BWR Core Attributes Uncertainties due to Multigroup Cross-Section Uncertainties,” Proceedings from Mathematical and Computation Topical Meeting, Monterey, Calif., Apr. 15-19, 2007).

ESM can also be used for adaptive simulation, which involves minimizing a regularized, covariance-weighted least-squares problem:

$${\vec{x}}_{a} = {min}_{\vec{x}} [ {‖ {\vec{d}}^{m} - {\vec{d}}_{0} - Π ( \overline{x} - {\overline{x}}_{0} ) ‖}_{{C}_{d}^{- 1}}^{2} + {α}^{2} {‖ \vec{x} - {\vec{x}}_{0} ‖}_{{C}_{x}^{- 1}}^{2} ] \qquad ( 2 )$$

where Cₓ is the few-group homogenized cross section covariance matrix, C_{d} is measured observables covariance matrix, d̅ is the core observables vector, x̅ is the few-group cross-sections vector, subscript ‘m’ denotes measured values, subscript ‘0’ denotes reference values, and α is the regularization parameter. Since Cₓ was rank deficient, the Moore-Penrose inverse was used. The few-group homogenized covariance matrix was used to constrain few-group cross-section adjustments to improve agreement between two BWR core simulators. The design core (DC) observables were calculated with the reference few-group cross-sections as input to the BWR simulator. The virtual core (VC) observables were created by perturbing the few-group cross-sections along a random linear combination of the few-group covariance matrix eigenvectors. A 4% Gaussian noise was applied to the VC nodal powers (used as surrogate to incore instrument readings), and the design core was adapted to the VC solution. The adapted core (AC) observables were calculated using the posterior estimate of the few-group cross-sections by solution to the inverse problem. The nodal power errors as a function of burnup are shown in FIG. 10. ‘AC1’ was calculated using the 44GROUPORNL multi-group covariance library (See B. T. REARDEN, “Sensitivity Utility Modules,” SCALE Code Package: ORNL/TM-2005/39, Version 5, Vol. III (2005)), and ‘AC2’ was calculated using the 44GROUPLANL multi-group covariance library. The 44GROUPLANL contains additional covariance information for gadolinium and zirconium. This library provided the best adaption, with errors near the applied noise level to the VC solution. This is due to the increased degrees of freedom in determining the inverse problem solution. The nodal power errors of the AC2 solution with the no-noise VC solution (‘VC*’) was near 1%, implying that ESM-based adaption is a successful noise filter.

The fidelity of adaption should increase with more informational content carried by the multi-group cross section covariances. For now, the uncertainty is assumed to be zero for nuclear reactions lacking uncertainty data in the libraries. Uncertainty-based decision analysis using ESM could aid in determining where efforts be focused on reducing existing uncertainties or quantifying unknown uncertainties.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

### REFERENCES

1. H. S. Abdel-Khalik and P. J. Turinsky, “Evaluation of Core Attributes Uncertainties due to Input Data Uncertainties,” Transactions of the American Nuclear Society, 92, San Diego, (2005).
2. H. S. Abdel-Khalik, “Adaptive Core Simulation,” Ph.D. Dissertation, North Carolina State University, December (2004).
3. Y. Ronen, Uncertainty Analysis, CRC Press (1988).
4. C. T. Kelley, Iterative Methods for Linear and Nonlinear Equations, Society for Industrial and Applied Mathematics, Philadelphia USA (1995).
5. “SCALE: A Modular Code System for Performing Standardized Computer Analyses for Licensing and Evaluation,” NUREG/CR-0200, ORNL/NUREG/CSD-2/R6 (2000).
6. M. E. Dunn, “PUFF-III: A Code for Processing ENDF Uncertainty Data Into Multi-group Covariance Matrices,” NUREG/CR-6650, ORNL/TM-1999/235 (2000).
7. J. Hadamard, Bull. University Princeton, 13, p. 49 (162).
8. A. N. Tikhonov, “Regularization of incorrectly posed problems,” Soviet Mathematics Doklady, 4, 1624 (1963).
9. H. W. Engl and W. Grever, “Using the L-Curve for determining optimal regularization parameters,” Numerische Mathematik, 69, p. 25, (1994).
10. A. Tarantola, Inverse Problem Theory and Methods for Model Parameter Estimation, Society for Industrial and Applied Mathematics, Philadelphia USA (2005).
11. M. D. DeHart, “TRITON: A Two Dimensional Depletion Sequence for Characterization of Spent Nuclear Fuel,” NUREG-0200, ORNL/NUREG/CSD-2/R7, DRAFT (2004).
12. B. R. Moore, P. J. Turinsky and A. A. Karve, “FORMOSA-B: A Boiling Water Reactor In-core Fuel Management Optimization Package,” Nuclear Technology, 126, p. 153 (1999).

That which is claimed is:

1. A method for selecting input data, including operational parameters for a nuclear system using a reduced order model of a complex model, the complex model comprising a set of equations that describe the nuclear system, the method comprising:
obtaining an adjoint model associated with the complex model;
calculating a plurality of r adjoint output data sets from the adjoint model using a plurality of r random sets of input data to the adjoint model;
determining a degree of correlation of the calculated adjoint output data sets;
downselecting a plurality of k reduced correlation subsets of the plurality of r adjoint output data sets based on the degree of correlation, wherein k<r;
inputting the plurality of k reduced correlation subsets of the adjoint output data as a plurality of input data sets to the complex computational model to provide a plurality of k output data sets;
determining a reduced order model for the complex computational model of the nuclear system based on the plurality of k input and output data sets of the complex computational model; and
selecting input and/or output data, including operational parameters for the nuclear system, using the reduced order model.

2. The method of claim 1, wherein the adjoint model Θ^{adj} is a model having a range numerically perpendicular to a null space of the complex computational model Θ such that R(Θ^{adj})⊥N(Θ), where two vectors that belong to the subspaces R(Θ^{adj}) and N(Θ) are numerically perpendicular if the dot product of the two vectors is less than a predetermined numerical error tolerance limit.

3. The method of claim 1, wherein selecting input and/or output data, including operational parameters for the nuclear system, further comprises:
comparing predetermined output data with output data calculated by the complex computational model based on reference input data; and
adapting the reference input data and calculated output data to increase agreement between the predetermined output data and the calculated output data using the reduced order model.

4. The method of claim 3 wherein set of predetermined output values includes experimental output data and/or design-targeted output data.

5. The method of claim 1, wherein the operational parameters comprises nuclear data; coefficients associated with empirical correlations embedded in the complex set of equations; physical constants including an equation of state, thermal conductivity, viscosity, a coefficient of expansion, and/or a stress-strain relationship; correlation coefficients including a critical heat flux, form and/or friction loss, and/or a bypass flow correlation; boundary and initial conditions, including power level, pressure, flow rate, fuel exposure, and/or isotopic composition.

6. The method of claim 1, wherein determining the degree of correlation comprises determining a numerical rank k of a matrix of adjoint output data Y^{adj} based on a predetermined numerical error tolerance limit, wherein the matrix Y_{adj} is defined by: Y^{adj}=[ y̅₁^{adj} y̅₂^{adj} . . . y̅ᵣ^{adj}], and y̅ᵢ^{adj}=Θ^{adj}( x̅ᵢ^{adj}) is an i^{th} adjoint output data set associated with an i^{th} adjoint input data set, and i runs from 1 to r.

7. The method of claim 6, further comprising calculating the numerical rank k of the matrix of adjoint output data sets using a matrix revealing decomposition, optionally using an Singular Value Decomposition (SVD) method such that Y^{adj}=U^{adj}S^{adj}V^{adjT}, wherein both U^{adj} and V^{adj} have k columns.

8. The method of claim 6, wherein the plurality of k reduced correlation input data and the plurality of k output data sets are represented by two matrices X^{RO}=[\vec{x}₁^{RO}\vec{x}₂^{RO} . . . \vec{x}ₖ^{RO}], and Y^{RO}=[\vec{y}₁^{RO} \vec{y}₂^{RO} . . . RO] X^{RO} is calculated using, optionally using an SVD decomposition such that X^{RO}=U^{adj}U^{adjT}Y^{adj}.

9. The method of claim 8, further comprising determining the reduced order model, denoted Θ_{RO}, such that: Y^{RO}=Θ^{RO}X^{RO}.

10. A computer program product for selecting operational parameters for a nuclear system using a reduced order model of a complex model, the complex model comprising a set of equations that describe the nuclear system, the computer program product comprising a computer readable medium having computer readable program code embodied therein, the computer readable program code comprising:
computer readable program code that is configured to obtain an adjoint model associated with the complex model;
computer readable program code that is configured to calculate a plurality of r output data sets from the adjoint model using a plurality of r random sets of input data to the adjoint model;
computer readable program code that is configured to determine a degree of correlation of the calculated adjoint output data sets;
computer readable program code that is configured to downselect a plurality of k reduced correlation subsets of the plurality of r adjoint output data sets based on the degree of correlation, wherein k<r;
computer readable program code that is configured to input the plurality of k reduced correlation subsets of the adjoint output data as a plurality of input data sets to the complex computational model to provide a plurality of k output data sets;
computer readable program code that is configured to determine a reduced order model for the complex computational model of the nuclear system based on the plurality of k input and output data sets of the complex computational model; and
computer readable program code that is configured to select input and/or output data, including operational parameters, for the nuclear system using the reduced order model.

11. The computer program product of claim 10, wherein the adjoint model Θ^{adj} is a model having a range numerically perpendicular to a null space of the complex computational model Θ such that R(Θ^{adj})⊥N(Θ), where two vectors that belong to the subspaces R(Θ^{adj}) and N(Θ) are numerically perpendicular if the dot product of the two vectors is less than a predetermined numerical error tolerance limit.

12. The computer program product of claim 10, wherein the computer readable program code that is configured to select input and/or output data, including operational parameters for the nuclear system, further comprises:
computer readable program code that is configured to compare predetermined output data with output data calculated by the complex computational model based on reference input data; and
computer readable program code that is configured to adapt the reference input data, including operational parameters, and calculated output data to increase agreement between the predetermined output data and the calculated output data using the reduced order model.

13. The computer program product of claim 12, wherein set of predetermined output data includes experimental output data and/or design-targeted output data.

14. The computer program product of claim 10, wherein the operational parameters comprises nuclear data, coefficients associated with empirical correlations embedded in the complex set of equations; physical constants including an equation of state, thermal conductivity, viscosity, a coefficient of expansion, and/or a stress-strain relationship; correlation coefficients including a critical heat flux, form and/or friction loss, and/or a bypass flow correlation; boundary and initial conditions, including power level, pressure, flow rate, fuel exposure, and/or isotopic composition.

15. The computer program product of claim 10, wherein the computer readable program code that is configured to determine the degree of correlation comprises computer readable program code that is configured to determine a numerical rank k of a matrix of adjoint output data Y^{adj} based on a predetermined numerical error tolerance limit, wherein the matrix Y^{adj} is defined by: Y^{adj}=[ y̅₁^{adj} y̅₂^{adj} . . . y̅ᵣ^{adj}], and y̅ᵢ^{adj}=Θ^{adj}( x̅ᵢ^{adj}) is an i^{th} adjoint output data set associated with an i^{th} adjoint input data set, and i runs from 1 to r.

16. The computer readable program code of claim 15, further comprising computer readable program code that is configured to calculate the numerical rank k of the matrix of adjoint output data sets using a matrix revealing decomposition, optionally an Singular Value Decomposition (SVD) method, such that Y^{adj}=U^{adj}S^{adj}V^{adjT}, wherein both U^{adj} and V^{adj} have k columns.

17. The computer readable program code of claim 15, wherein the plurality of k reduced correlation input data and the plurality of k output data sets are represented by two matrices X^{RO}=[\vec{x}₁^{RO} \vec{x}₂^{RO} . . . \vec{x}ₖ^{RO}], and Y^{RO}=[\vec{y}₁^{RO} \vec{y}₂^{R0} . . . \vec{y}ₖ^{RO}], respectively, and X^{RO} is calculated using, optionally an SVD decomposition such that X^{RO}=U^{adj}U^{adjT}Y^{adj}.

18. The computer readable program code of claim 17, further comprising computer readable program code that is configured to determine the reduced order model, denoted Θ_{RO}, such that: Y^{RO}=Θ_{RO}X^{RO}.

19. A method for selecting operational parameters for a complex system using a reduced order model of a complex model, the complex model comprising a set of equations that describe the nuclear system, the method comprising:
obtaining an adjoint model associated with the complex model;
calculating output data from the adjoint model using a plurality of r random sets of input data to the adjoint model;
determining a degree of correlation of the calculated adjoint output data;
downselecting a plurality of k reduced correlation subsets of the plurality of r adjoint output data sets based on the degree of correlation, wherein k<r;
inputting the plurality of k reduced correlation subsets of the adjoint output data as a plurality of input data sets to the complex computational model to provide a plurality of k output data sets;
determining a reduced order model for the complex computational model of the complex system based on the plurality of k input and output data sets of the complex computational model; and
selecting input and/or output data, including operational parameters, for the nuclear system using the reduced order model.

20. The method of claim 19, wherein the complex system comprises social systems, social networks modeling systems, meteorological modeling systems, weather modeling systems, climate modeling systems, satellite data assimilation systems for numerical weather forecast, sea surface temperature modeling systems, and ocean research modeling systems, environmental systems, geophysical systems, earth atmosphere modeling systems, earthquake modeling systems, biological systems, ecological systems, modeling systems that model interactions between physical and biological systems, medical imaging systems, machine-learning systems, information retrieval systems, and/or data mining systems.

21. The method of claim 19, wherein the adjoint model Θ^{adj} is a model having a range numerically perpendicular to a null space of the complex computational model Θ such that R(Θ^{adj})⊥N(Θ), where two vectors that belong to the subspaces R(Θ^{adj}) and N(Θ) are numerically perpendicular if the dot product of the two vectors is less than a predetermined numerical error tolerance limit.

22. A system for selecting input data, including operational parameters for a nuclear system using a reduced order model of a complex model, the complex model comprising a set of equations that describe the nuclear system, the system comprising:
means for obtaining an adjoint model associated with the complex model;
means for calculating a plurality of r adjoint output data sets from the adjoint model using a plurality of r random sets of input data to the adjoint model;
means for determining a degree of correlation of the calculated adjoint output data sets;
means for downselecting a plurality of k reduced correlation subsets of the plurality of r adjoint output data sets based on the degree of correlation, wherein k<r;
means for inputting the plurality of k reduced correlation subsets of the adjoint output data as a plurality of input data sets to the complex computational model to provide a plurality of k output data sets;
means for determining a reduced order model for the complex computational model of the nuclear system based on the plurality of k input and output data sets of the complex computational model; and
means for selecting input and/or output data, including operational parameters for the nuclear system, using the reduced order model.
